(19) United States
(12) Patent Application Publication
(10) Pub. No.: US 2025/0304204 A1
(43) Pub. Date: Oct. 2, 2025

(54) HUMAN-POWERED VEHICLE COMPONENT

(71) Applicant: SHIMANO INC., Sakai City (JP)

(72) Inventors: Ryota YAMAGUCHI, Sakai City (JP); Tatsuya SAKURAI, Sakai City (JP); Kenji NAKANO, Sakai City (JP)

(73) Assignee: SHIMANO INC., Sakai City (JP)

(21) Appl. No.: 18/624,024

(22) Filed: Apr. 1, 2024

(51) Int. Cl. B62J 45/20

(52) U.S. Cl. CPC B62J 45/20

(57) ABSTRACT

A human-powered vehicle component is configured to be operated by an additional human-powered vehicle component configured to be powered by at least one of a first electric power source and a second electric power source. The human-powered vehicle component comprises electronic controller circuitry configured to obtain whether the additional human-powered vehicle component is powered by the first electric power source based on information relating to the additional human-powered vehicle component.

### BACKGROUND

### Technical Field

The present invention relates to a human-powered vehicle component.

### Background Information

In recent years, some human-powered vehicles are provided with electric components or devices to make it easier for the rider to operate the human-powered vehicle. Such electric components are powered by an electric power source. One of objects of the present disclosure is to execute a suitable control depending on an electric power source.

### SUMMARY

In accordance with a first aspect of the present invention, a human-powered vehicle component is configured to be operated by an additional human-powered vehicle component configured to be powered by at least one of a first electric power source and a second electric power source. The human-powered vehicle component comprises electronic controller circuitry configured to obtain whether the additional human-powered vehicle component is powered by the first electric power source based on information relating to the additional human-powered vehicle component.

With the human-powered vehicle component according to the first aspect, it is possible to execute a suitable control depending on whether the additional human-powered vehicle component is powered by the first electric power source.

In accordance with a second aspect of the present invention, the human-powered vehicle system according to the first aspect is configured so that the first electric power source includes an energy harvesting device.

With the human-powered vehicle component according to the second aspect, it is possible to execute a suitable control depending on whether the additional human-powered vehicle component is powered by the energy harvesting device.

In accordance with a third aspect of the present invention, a human-powered vehicle component comprises electronic controller circuitry configured to obtain whether an additional human-powered vehicle component is powered by an energy harvesting device based on information relating to the additional human-powered vehicle component.

With the human-powered vehicle component according to the third aspect, it is possible to execute a suitable control depending on whether the additional human-powered vehicle component is powered by the energy harvesting device.

In accordance with a fourth aspect of the present invention, the human-powered vehicle system according to the second or third aspect is configured so that the electronic controller circuitry is configured to obtain whether the additional human-powered vehicle component is currently powered by the energy harvesting device based on the information.

With the human-powered vehicle component according to the fourth aspect, it is possible to execute a reliably suitable control depending on whether the additional human-powered vehicle component is powered by the energy harvesting device.

In accordance with a fifth aspect of the present invention, the human-powered vehicle system according to any one of the first to fourth aspects is configured so that the information is included in a signal transmitted from the additional human-powered vehicle component.

With the human-powered vehicle component according to the fifth aspect, it is possible to obtain the information relating to the additional human-powered vehicle component using the signal.

In accordance with a sixth aspect of the present invention, the human-powered vehicle system according to any one of the first to fifth aspects is configured so that the information includes attribute information of the additional human-powered vehicle component. The attribute information indicates which kind of electric power source powers the human-powered vehicle component.

With the human-powered vehicle component according to the sixth aspect, it is possible to reliably obtain whether the additional human-powered vehicle component is powered by the first electric power source using the attribute information.

In accordance with a seventh aspect of the present invention, the human-powered vehicle system according to any one of the first to sixth aspects is configured so that the information includes identification information of the additional human-powered vehicle component.

With the human-powered vehicle component according to the seventh aspect, it is possible to precisely recognize the additional human-powered vehicle component using the identification information.

In accordance with an eighth aspect of the present invention, a human-powered vehicle component is configured to be operated by an additional human-powered vehicle component configured to be powered by at least one of a first electric power source and a second electric power source. The human-powered vehicle component comprises an electric actuator and electronic controller circuitry configured to control the electric actuator based on whether the additional human-powered vehicle component is powered by the first electric power source.

With the human-powered vehicle component according to the eighth aspect, it is possible to execute a suitable control of the electric actuator depending on whether the additional human-powered vehicle component is powered by the first electric power source.

In accordance with a ninth aspect of the present invention, the human-powered vehicle system according to the eighth aspect is configured so that the first electric power source includes an energy harvesting device.

With the human-powered vehicle component according to the ninth aspect, it is possible to execute a suitable control of the electric actuator depending on whether the additional human-powered vehicle component is powered by the energy harvesting device.

In accordance with a tenth aspect of the present invention, a human-powered vehicle component comprises an electric actuator and electronic controller circuitry configured to control the electric actuator based on whether an additional human-powered vehicle component is powered by an energy harvesting device.

With the human-powered vehicle component according to the tenth aspect, it is possible to execute a suitable control of the electric actuator depending on whether the additional human-powered vehicle component is powered by the energy harvesting device.

In accordance with an eleventh aspect of the present invention, the human-powered vehicle system according to any one of the second to tenth aspects is configured so that the electronic controller circuitry is configured to execute a first control in a case where the additional human-powered vehicle component is powered by the energy harvesting device. The electronic controller circuitry is configured to execute a second control different from the first control in a case where the additional human-powered vehicle component is powered by an electric power source other than the energy harvesting device.

With the human-powered vehicle component according to the eleventh aspect, it is possible to execute a suitable control of the electric actuator depending on whether the additional human-powered vehicle component is powered by the energy harvesting device.

In accordance with a twelfth aspect of the present invention, the human-powered vehicle system according to the eleventh aspect is configured so that the electronic controller circuitry is configured to control, in the first control, an electric actuator to move a movable member in response to the signal in a case where a first condition is met. The electronic controller circuitry is configured to control, in the second control, the electric actuator to move the movable member in response to the signal in a case where a second condition different from the first condition is met.

With the human-powered vehicle component according to the twelfth aspect, it is possible to execute a reliably suitable control of the electric actuator depending on whether the additional human-powered vehicle component is powered by the energy harvesting device.

In accordance with a thirteenth aspect of the present invention, the human-powered vehicle system according to the twelfth aspect is configured so that the electronic controller circuitry is configured to ignore, in the first control, the signal indicating that the electric actuator moves the movable member in a case where the first condition is not met.

With the human-powered vehicle component according to the thirteenth aspect, it is possible to execute a more reliably suitable control of the electric actuator depending on whether the additional human-powered vehicle component is powered by the energy harvesting device.

In accordance with a fourteenth aspect of the present invention, the human-powered vehicle system according to the twelfth or thirteenth aspect is configured so that the electronic controller circuitry is configured to ignore, in the second control, the signal indicating that the electric actuator moves the movable member in a case where the second condition is not met.

With the human-powered vehicle component according to the fourteenth aspect, it is possible to execute a more reliably suitable control of the electric actuator depending on whether the additional human-powered vehicle component is powered by the energy harvesting device.

In accordance with a fifteenth aspect of the present invention, the human-powered vehicle system according to any one of the twelfth to fourteenth aspects is configured so that the electronic controller circuitry is configured to control, in the first control, the electric actuator to move the movable member in a case where the first condition that a determination time elapses from a previous action in which the electric actuator moves the movable member is met.

With the human-powered vehicle component according to the fifteenth aspect, it is possible to execute a more reliably suitable control of the electric actuator depending on whether the additional human-powered vehicle component is powered by the energy harvesting device.

In accordance with a sixteenth aspect of the present invention, the human-powered vehicle system according to any one of the twelfth to fifteenth aspects is configured so that the electronic controller circuitry is configured to control, in the second control, the electric actuator to move the movable member in a case where the second condition which is free of the determination time is met.

With the human-powered vehicle component according to the sixteenth aspect, it is possible to execute a more reliably suitable control of the electric actuator depending on whether the additional human-powered vehicle component is powered by the energy harvesting device.

In accordance with a seventeenth aspect of the present invention, the human-powered vehicle system according to any one of the twelfth to sixteenth aspects is configured so that the electronic controller circuitry is configured to control, in the second control, the electric actuator to move the movable member in a case where the second condition that sequence information included in the signal is different from previous sequence information included in a previous signal previously received by the human-powered vehicle component is met.

With the human-powered vehicle component according to the seventeenth aspect, it is possible to execute a more reliably suitable control of the electric actuator depending on whether the additional human-powered vehicle component is powered by the energy harvesting device.

In accordance with an eighteenth aspect of the present invention, the human-powered vehicle system according to any one of the first to seventeenth aspects further comprises communicator circuitry configured to receive the signal including the information from the additional human-powered vehicle component.

With the human-powered vehicle component according to the eighteenth aspect, it is possible to reliably receive the signal including the information.

In accordance with a nineteenth aspect of the present invention, a human-powered vehicle component is configured to be powered by at least one of a first electric power source and a second electric power source. The human-powered vehicle component comprises communicator circuitry configured to transmit a signal including information indicating whether the human-powered vehicle component is powered by the first electric power source.

With the human-powered vehicle component according to the nineteenth aspect, it is possible to reliably receive the signal including the information.

In accordance with a twentieth aspect of the present invention, the human-powered vehicle system according to the nineteenth aspect is configured so that the first electric power source includes an energy harvesting device.

With the human-powered vehicle component according to the twentieth aspect, it is possible to reliably receive the signal including the information indicating whether the human-powered vehicle component is powered by energy harvesting device.

In accordance with a twenty-first aspect of the present invention, a human-powered vehicle component comprises communicator circuitry configured to transmit a signal including first energy information indicating that the human-powered vehicle component is powered by an energy harvesting device.

With the human-powered vehicle component according to the twenty-first aspect, it is possible to reliably transmit the signal including the first energy information.

In accordance with a twenty-second aspect of the present invention, the human-powered vehicle system according to any one of the nineteenth to twenty-first aspects is configured so that the human-powered vehicle component is configured to operate an additional human-powered vehicle component.

With the human-powered vehicle component according to the twenty-second aspect, it is possible to operate the additional human-powered vehicle component using the human-powered vehicle component.

In accordance with a twenty-third aspect of the present invention, the human-powered vehicle system according to any one of the nineteenth to twenty-second aspects is configured so that the communicator circuitry is configured to transmit the signal including information including attribute information of the human-powered vehicle component. The attribute information includes which kind of electric power source powers the human-powered vehicle component.

With the human-powered vehicle component according to the twenty-third aspect, it is possible to reliably transmit the signal including the attribute information.

In accordance with a twenty-fourth aspect of the present invention, the human-powered vehicle system according to the twenty-third aspect is configured so that the attribute information includes the first energy information.

With the human-powered vehicle component according to the twenty-fourth aspect, it is possible to reliably transmit the signal including the first energy information.

In accordance with a twenty-fifth aspect of the present invention, the human-powered vehicle system according to the twenty-third or twenty-fourth aspect is configured so that the attribute information includes second energy information indicating that the human-powered vehicle component is powered by an electric power source other than the energy harvesting device.

With the human-powered vehicle component according to the twenty-fifth aspect, it is possible to reliably transmit the signal including the second energy information.

In accordance with a twenty-sixth aspect of the present invention, the human-powered vehicle system according to any one of the nineteenth to twenty-fifth aspects is configured so that the information includes identification information of the human-powered vehicle component.

With the human-powered vehicle component according to the twenty-sixth aspect, it is possible to reliably transmit the signal including the identification information.

In accordance with a twenty-seventh aspect of the present invention, the human-powered vehicle system according to any one of the twenty-first to twenty-sixth aspects further comprises electronic controller circuitry electrically connected to the communicator circuitry. The electronic controller circuitry is configured to store the first energy information. The electronic controller circuitry is configured to control the communicator circuitry to transmit the signal including the first energy information.

With the human-powered vehicle component according to the twenty-seventh aspect, it is possible to reliably transmit the signal including the first energy information.

In accordance with a twenty-eighth aspect of the present invention, the human-powered vehicle system according to the twenty-seventh aspect is configured so that the electronic controller circuitry is configured to control the communicator circuitry to transmit a first signal including the first energy information in a case where the human-powered vehicle component is powered by the energy harvesting device. The electronic controller circuitry is configured to control the communicator circuitry to transmit a second signal including second energy information indicating that the human-powered vehicle component is powered by an electric power source other than the energy harvesting device in a case where the human-powered vehicle component is powered by the electric power source other than the energy harvesting device.

With the human-powered vehicle component according to the twenty-eighth aspect, it is possible to reliably transmit the first signal including the first energy information and the second signal including the second energy information.

In accordance with a twenty-ninth aspect of the present invention, the human-powered vehicle system according to the twenty-seventh aspect is configured so that the electronic controller circuitry is configured to control the communicator circuitry to transmit the first signal which is free of sequence information in a case where the human-powered vehicle component is powered by the energy harvesting device. The electronic controller circuitry is configured to control the communicator circuitry to transmit the second signal including the sequence information in a case where the human-powered vehicle component is powered by the electric power source other than the energy harvesting device.

With the human-powered vehicle component according to the twenty-ninth aspect, it is possible to reduce power consumption of the human-powered vehicle component since the first signal is free of the sequence information.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including a human-powered vehicle system including at least two human-powered vehicle components in accordance with one of embodiments.

FIG. 2 is a side elevational view of one of the at least two human-powered vehicle components illustrated in FIG. 1.

FIG. 3 is a side elevational view of another of the at least two human-powered vehicle components illustrated in FIG. 1.

FIG. 4 is a side elevational view of another of the at least two human-powered vehicle components illustrated in FIG. 1.

FIG. 5 is a side elevational view of another of the at least two human-powered vehicle components illustrated in FIG. 1.

FIG. 6 is a side elevational view of another of the at least two human-powered vehicle components illustrated in FIG. 1.

FIG. 7 is a perspective view of another of the at least two human-powered vehicle components illustrated in FIG. 1.

FIG. 8 is a cross-sectional view of the human-powered vehicle component taken along line VIII-VIII of FIG. 7.

FIG. 9 is a schematic block diagram of the human-powered vehicle system illustrated in FIG. 1.

FIGS. 10 and 11 are timing charts of a control executed by the human-powered vehicle system illustrated in FIG. 9 (first electric power source).

FIG. 12 is a timing charts of a control executed by the human-powered vehicle system illustrated in FIG. 9 (second electric power source).

FIGS. 13 and 14 are flowcharts of a control executed by one of the at least two human-powered vehicle components of the human-powered vehicle system illustrated in FIG. 1.

FIG. 15 is a flowchart of a control executed by another of the at least two human-powered vehicle components of the human-powered vehicle system illustrated in FIG. 1.

FIGS. 16 and 17 are cross-sectional views of one of the at least two human-powered vehicle components flowcharts in accordance with a modification.

### DESCRIPTION OF THE EMBODIMENTS

The embodiments will now be described with reference to the accompanying drawings, wherein like reference numerals designate corresponding or identical elements throughout the various drawings.

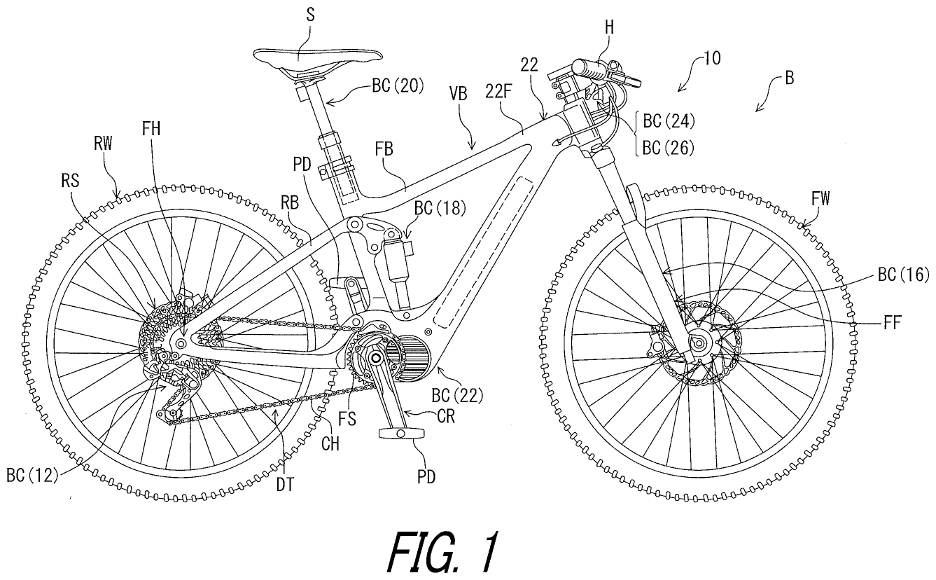

Referring initially to FIG. 1, a human-powered vehicle B includes a human-powered vehicle system 10 in accordance with one of embodiments. The human-powered vehicle system 10 includes at least one human-powered vehicle component BC. In the present embodiment, the human-powered vehicle B is illustrated as an e-bike that uses a driving force of an electric motor in addition to a human driving force for propulsion. However, the human-powered vehicle system 10 can be applied to any other type of human-powered vehicles such as, for example, a mountain bike, a cyclocross bicycle, a gravel bike, a city bike, a cargo bike, and a recumbent bike.

In the present application, the term “human-powered vehicle” includes a vehicle to travel with a motive power including at least a human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

Basically, the human-powered vehicle system 10 is directed to pairing at least two devices such that the at least two devices can wirelessly communicate with each other. Thus, the term “human-powered vehicle component” as used herein generically refers to all the human-powered vehicle components BC of the human-powered vehicle B that are configured to wirelessly communicate with another one of the human-powered vehicle components BC of the human-powered vehicle B after being paired together. The components or parts of the human-powered vehicle B that cannot wirelessly communicate will not be referred to as “human-powered vehicle component” herein.

As seen in FIG. 1, the human-powered vehicle B includes a vehicle body VB, a wheel FW, and a wheel RW. The wheel FW is rotatably coupled to the vehicle body VB. The wheel RW is rotatably coupled to the vehicle body VB. The vehicle body VB is supported by the wheels FW and RW. The wheel FW can also be referred to as a front wheel FW. The wheel RW can also be referred to as a rear wheel RW.

The vehicle body VB includes a front frame body FB, a rear frame body RB, a handlebar H, and a front fork FF. The rear frame body RB includes a swing arm. The rear frame body RB is movably coupled to the front frame body FB. The rear frame body RB is pivotally coupled to the front frame body FB. The front fork FF is pivotally coupled to the front frame body FB. The handlebar H is coupled to the front fork FF to be pivotable relative to the front frame body FB along with the front fork FF.

The human-powered vehicle B further includes a drivetrain DT. Here, for example, the drivetrain DT is a chain-drive type and includes a crank CR, at least one front sprocket FS, at least two rear sprockets RS, a chain CH, and pedals PD. The crank CR is rotatably coupled to the vehicle body VB. The at least one front sprocket FS is coupled to the crank CR to rotate relative to the vehicle body VB along with the crank CR. The rear sprockets RS are provided on a hub assembly FH of the wheel RW. The chain CH is configured to be engaged with one of the at least one front sprocket FS and one of the at least two rear sprockets RS. The pedals PD are coupled to the crank CR. A human driving force is applied to the pedals PD by a rider such that the driving force is transmitted to the wheel RW via the at least one front sprocket FS, the chain CH, and the at least two rear sprockets RS. While the drivetrain DT is illustrated as a chain-drive type of drivetrain, the drivetrain DT can be selected from any type of drivetrain and can be a belt-drive type or a shaft-drive type.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle B while the user faces toward a handlebar or steering. Examples of the user's standard position include a saddle and a seat. Accordingly, these terms, as utilized to describe the human-powered vehicle system 10, the human-powered vehicle component BC, or other components, should be interpreted relative to the human-powered vehicle B equipped with the human-powered vehicle system 10, the human-powered vehicle component BC, or other components as used in an upright riding position on a horizontal surface.

As seen in FIG. 1, the at least one human-powered vehicle component BC includes a gear changer 12, a suspension 16, a suspension 18, an adjustable seatpost 20, and an assist drive unit 22. Namely, the human-powered vehicle B includes the gear changer 12, the suspension 16, the suspension 18, the adjustable seatpost 20, and the assist drive unit 22. The gear changer 12 is configured to be mounted to the vehicle body VB. The suspension 16 is configured to be mounted to the vehicle body VB. The suspension 18 is configured to be mounted to the vehicle body VB. The adjustable seatpost 20 is configured to be mounted to the vehicle body VB. The assist drive unit 22 is configured to be mounted to the vehicle body VB.

As seen in FIG. 1, the gear changer 12 is configured to change a gear ratio of the human-powered vehicle B. The gear ratio is a ratio of a rotational speed of the at least two rear sprockets RS to a rotational speed of the at least one front sprocket FS. The gear changer 12 is configured to shift the chain CH relative to the at least two rear sprockets RS. In the present embodiment, the gear changer 12 includes a rear derailleur. In the present embodiment, the gear changer 12 includes a rear derailleur. However, the gear changer 12 can include another type of gear changer 12 if needed or desired. Examples of another type of gear changer 12 include a front derailleur and an internal-gear hub.

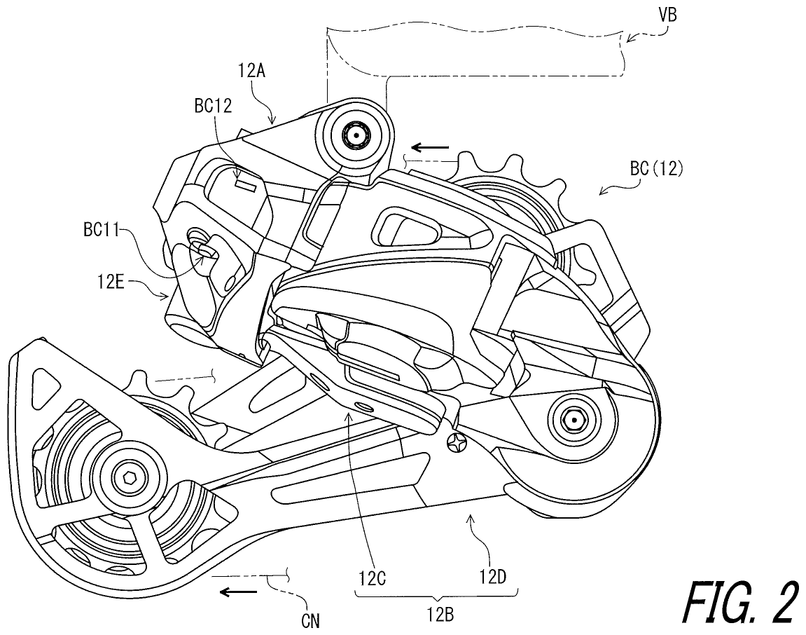

As seen in FIG. 2, the gear changer 12 further comprises a base member 12A and a movable member 12B. The base member 12A is mountable to the vehicle body VB. The movable member 12B is movable relative to the base member 12A. For example, the movable member 12B includes a linkage 12C and a chain guide 12D. The chain guide 12D is contactable with the chain CH. The linkage 12C movably couples the base member 12A and the chain guide 12D.

The gear changer 12 comprises an electric actuator 12E. The electric actuator 12E is configured to generate an actuation force. Examples of the electric actuator 12E include an electric motor. The electric actuator 12E is coupled to at least one of the base member 12A and the movable member 12B to move the movable member 12B relative to the base member 12A. The electric actuator 12E is at least partially provided to at least one of the base member 12A and the movable member 12B. The electric actuator 12E can be configured to be controlled based on a control signal transmitted from another device or to be automatically controlled based on information relating to the human-powered vehicle B.

As seen in FIG. 1, the suspension 16 is configured to absorb or damp shocks or vibrations generated by riding on rough terrain. The suspension 16 is installed in the front fork FF. The suspension 16 and the front fork FF constitute a suspension fork. The suspension 16 is configured to absorb or damp shocks or vibrations transmitted from at least one of the wheels FW and RW.

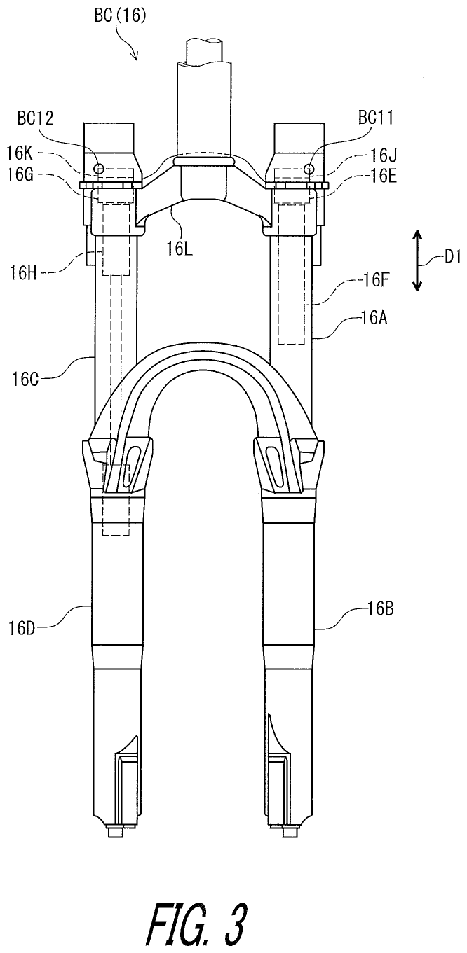

As seen in FIG. 3, the suspension 16 includes a first longitudinal member 16A and a second longitudinal member 16B. The first longitudinal member 16A and the second longitudinal member 16B are relatively movable. The suspension 16 includes a crown 16L. The first longitudinal member 16A is coupled to the crown 16L. The wheel FW is rotatably coupled to the second longitudinal member 16B. For example, the first longitudinal member 16A and the second longitudinal member 16B define a fluid chamber filled with a fluid such as oil.

The suspension 16 includes a third longitudinal member 16C and a fourth longitudinal member 16D. The third longitudinal member 16C and the fourth longitudinal member 16D are relatively movable. The third longitudinal member 16C is coupled to the crown 16L. The wheel FW is rotatably coupled to the fourth longitudinal member 16D. For example, the third longitudinal member 16C and the fourth longitudinal member 16D define an air chamber filled with air.

The suspension 16 comprises an electric actuator 16E and an actuator driver 16J. The electric actuator 16E is configured to generate an actuation force. Examples of the electric actuator 16E include an electric motor. The actuator driver 16J is electrically connected to the electric actuator 16E to control the electric actuator 16E.

The suspension 16 includes a state changing structure 16F configured to change the state of the suspension 16 between a first state and a second state. The electric actuator 16E is configured to actuate the state changing structure 16F to change the state of the suspension 16 between the first state and the second state. For example, the state changing structure 16F includes a valve unit. The electric actuator 16E is coupled to the state changing structure 16F. The electric actuator 16E is configured to actuate the state changing structure 16F to change the state of the suspension 16 between the first state and the second state.

For example, the state changing structure 16F is configured to allow the first longitudinal member 16A and the second longitudinal member 16B to relatively move under a first damping property in the first state. The state changing structure 16F is configured to allow the first longitudinal member 16A and the second longitudinal member 16B to relatively move under a second damping property in the second state. The second damping property is different from the first damping property.

The suspension 16 comprises an electric actuator 16G and an actuator driver 16K. The electric actuator 16G is configured to generate an actuation force. Examples of the electric actuator 16G include an electric motor. The actuator driver 16K is electrically connected to the electric actuator 16G to control the electric actuator 16G.

The suspension 16 includes a state changing structure 16H configured to change the state of the suspension 16 between a third state and a fourth state. The electric actuator 16E is configured to actuate the state changing structure 16H to change the state of the suspension 16 between the third state and the fourth state. For example, the state changing structure 16H includes a valve unit. The electric actuator 16G is coupled to the state changing structure 16H. The electric actuator 16G is configured to actuate the state changing structure 16H to change the state of the suspension 16 between the first state and the second state.

For example, the state changing structure 16H is configured to allow the third longitudinal member 16C and the fourth longitudinal member 16D to relatively move within a first stroke in the third state. The state changing structure 16H is configured to allow the third longitudinal member 16C and the fourth longitudinal member 16D to relatively move within a second stroke in the fourth state. The second stroke is different from the first stroke. One of the first stroke and the second stroke can be zero.

In the present embodiment, the suspension 16 includes the electric actuator 16E, the state changing structure 16F, the electric actuator 16G, and the state changing structure 16H. However, the electric actuator 16E and the state changing structure 16F can be omitted from the suspension 16 if needed or desired. The electric actuator 16G and the state changing structure 16H can be omitted from the suspension 16 if needed or desired. Furthermore, the suspension 16 can include another type of a state changing structure other than the state changing structures 16F and 16H if needed or desired.

As seen in FIG. 1, the suspension 18 is configured to absorb or damp shocks or vibrations generated by riding on rough terrain. The suspension 18 is coupled to the front frame body FB and the rear frame body RB. The suspension 18 is configured to absorb or damp shocks or vibrations transmitted from at least one of the wheels FW and RW.

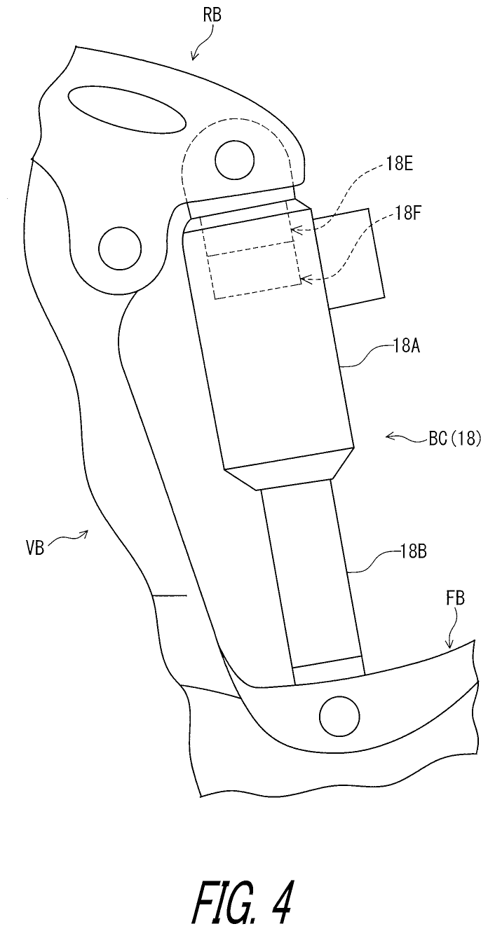

As seen in FIG. 4, the suspension 18 includes a first longitudinal member 18A and a second longitudinal member 18B. The first longitudinal member 18A and the second longitudinal member 18B are relatively movable. The first longitudinal member 18A and the second longitudinal member 18B define an air chamber or a fluid chamber. The first longitudinal member 18A is pivotally coupled to the rear frame body RB. The second longitudinal member 18B is pivotally coupled to the front frame body FB.

The suspension 18 comprises an electric actuator 18E. The electric actuator 18E is configured to generate an actuation force. Examples of the electric actuator 18E include an electric motor.

The suspension 18 includes a state changing structure 18F configured to change the state of the suspension 18 between a first state and a second state. The electric actuator 18E is configured to actuate the state changing structure 18F to change the state of the suspension 18 between the first state and the second state. For example, the state changing structure 18F includes a valve unit. The electric actuator 18E is coupled to the state changing structure 18F. The electric actuator 18E is configured to actuate the state changing structure 18F to change the state of the suspension 18 between the first state and the second state.

The state changing structure 18F is configured to allow the first longitudinal member 18A and the second longitudinal member 18B to relatively move within a first stroke or under a first damping property in the first state. The state changing structure 18F is configured to allow the first longitudinal member 18A and the second longitudinal member 18B to relatively move within a second stroke or under a second damping property in the second state.

As seen in FIG. 1, the adjustable seatpost 20 is configured to change a height of the saddle S relative to the vehicle body VB. The adjustable seatpost 20 has an adjustable state and a locked state. The adjustable seatpost 20 allows the user to change the height of the saddle S in the adjustable state. The adjustable seatpost 20 is locked to maintain the height of the saddle S in the locked state. The adjustable seatpost 20 is configured to change the state of the adjustable seatpost 20 between the adjustable state and the locked state.

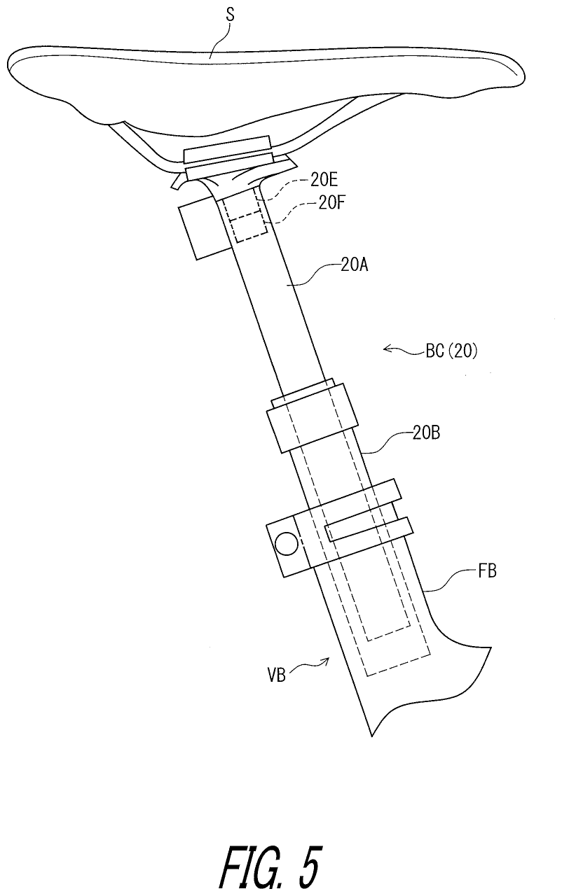

As seen in FIG. 5, the adjustable seatpost 20 includes a first longitudinal member 20A and a second longitudinal member 20B. The first longitudinal member 20A and the second longitudinal member 20B are relatively movable. The saddle S is coupled to the first longitudinal member 20A. The second longitudinal member 20B is coupled to the vehicle body VB.

The adjustable seatpost 20 comprises an electric actuator 20E. The electric actuator 20E is configured to generate an actuation force. Examples of the electric actuator 20E include an electric motor.

The adjustable seatpost 20 includes a state changing structure 20F configured to change the state of the adjustable seatpost 20 between the adjustable state and the locked state. The electric actuator 20E is configured to actuate the state changing structure 20F to change the state of the adjustable seatpost 20 between the adjustable state and the locked state. For example, the state changing structure 20F includes a valve unit. The electric actuator 20E is coupled to the state changing structure 20F. The electric actuator 20E is configured to actuate the state changing structure 20F to change the state of the adjustable seatpost 20 between the adjustable state and the locked state.

The state changing structure 20F is configured to allow the first longitudinal member 20A and the second longitudinal member 20B to relatively move in the adjustable state. The state changing structure 20F is configured to restrict the first longitudinal member 20A and the second longitudinal member 20B from relatively moving in the locked state.

As seen in FIG. 1, the assist drive unit 22 is configured to assist propulsion of the human-powered vehicle B. The assist drive unit 22 is configured to change an assist ratio depending on a human power applied to the human-powered vehicle B. For example, the assist drive unit 22 is configured to change the assist ratio depending on pedaling torque applied to the crank CR.

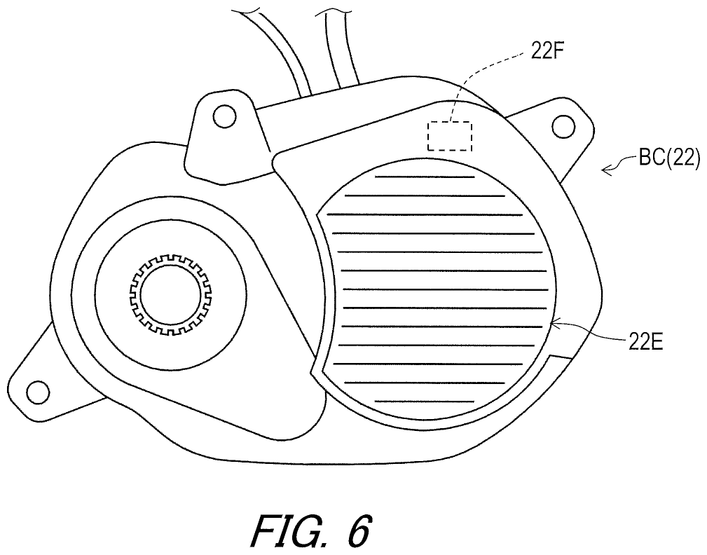

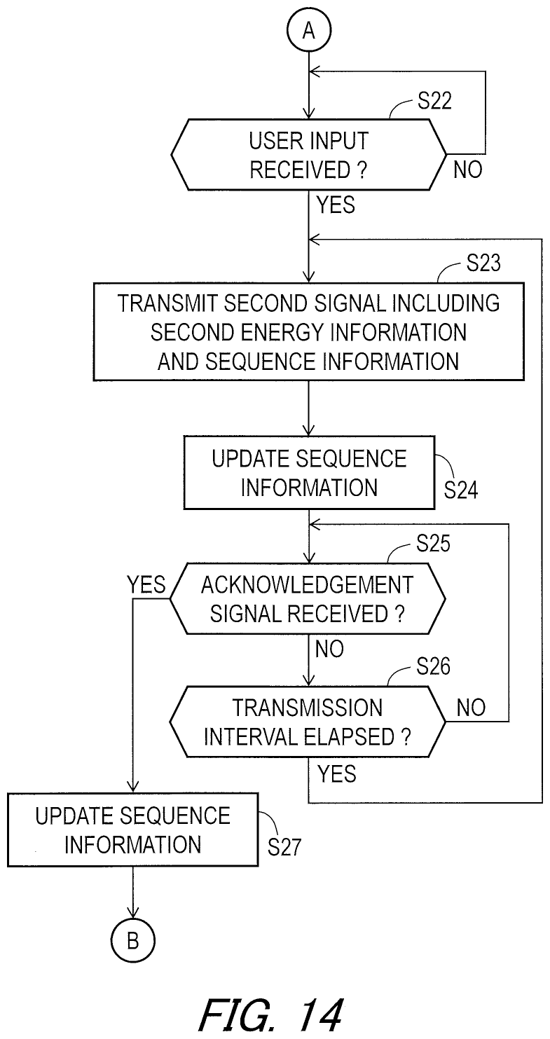

As seen in FIG. 6, the assist drive unit 22 comprises a housing 22A, an electric actuator 22E, and an actuator driver 22F. The electric actuator 22E is at least partially provided in the housing 22A. The electric actuator 22E is configured to generate an actuation force. The actuator driver 22F (see e.g., FIG. 14) is electrically connected to the electric actuator 22E to control the electric actuator 22E. Examples of the electric actuator 22E include an electric motor. The electric actuator 22E is configured to apply the actuation force to the human-powered vehicle B to assist propulsion of the human-powered vehicle B.

As seen in FIG. 1, the at least one human-powered vehicle component BC includes an operating device 24 and an operating device 26. The operating device 24 is configured to be mounted to the handlebar H. The operating device 24 is configured to receive a user input. The operating device 24 is configured to operate at least one of the at least one human-powered vehicle component BC in response to the user input. The operating device 26 is configured to be mounted to the handlebar H. The operating device 26 is configured to receive an additional user input. The operating device 26 is configured to operate at least one of the at least one human-powered vehicle component BC in response to the additional user input.

The operating device 24 is configured to operate at least one of the gear changer 12, the suspension 16, the suspension 18, the adjustable seatpost 20, and the assist drive unit 22 in response to the user input. The operating device 26 is configured to operate at least one of the gear changer 12, the suspension 16, the suspension 18, the adjustable seatpost 20, and the assist drive unit 22 in response to the additional user input. The at least one human-powered vehicle component BC can include another operating device other than the operating device 24 and the operating device 26 if needed or desired.

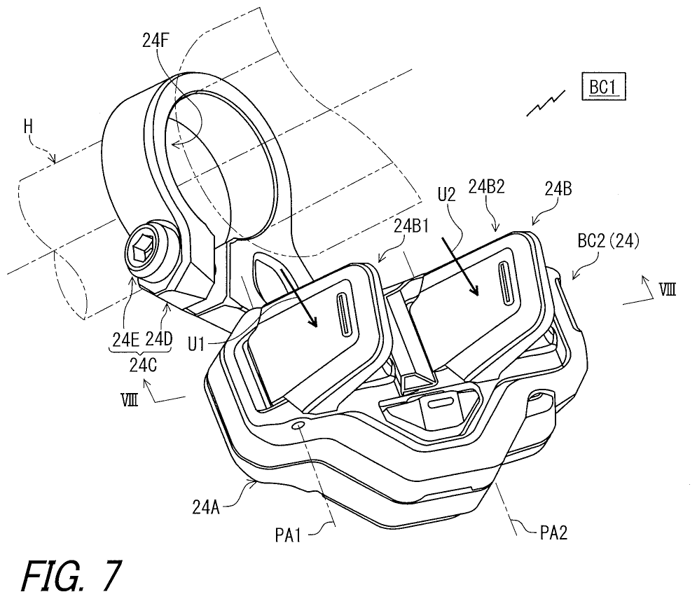

As seen in FIG. 7, the operating device 24 includes a housing 24A, a user interface 24B, and a mounting portion 24C. The housing 24A is configured to be mounted to the vehicle body VB of the human-powered vehicle B. The user interface 24B is configured to be operated by the user to control at least one of the at least one human-powered vehicle component BC while the human-powered vehicle B is running. The mounting portion 24C is configured to couple the housing 24A and the vehicle body VB. The mounting portion 24C is configured to couple the housing 24A and the handlebar H of the vehicle body VB. For example, the mounting portion 24C includes a clamp 24D and a clamp fastener 24E. The clamp 24D includes a clamp opening 24F through which the handlebar H is to extend. The clamp fastener 24E is configured to fasten the clamp 24D to the handlebar H.

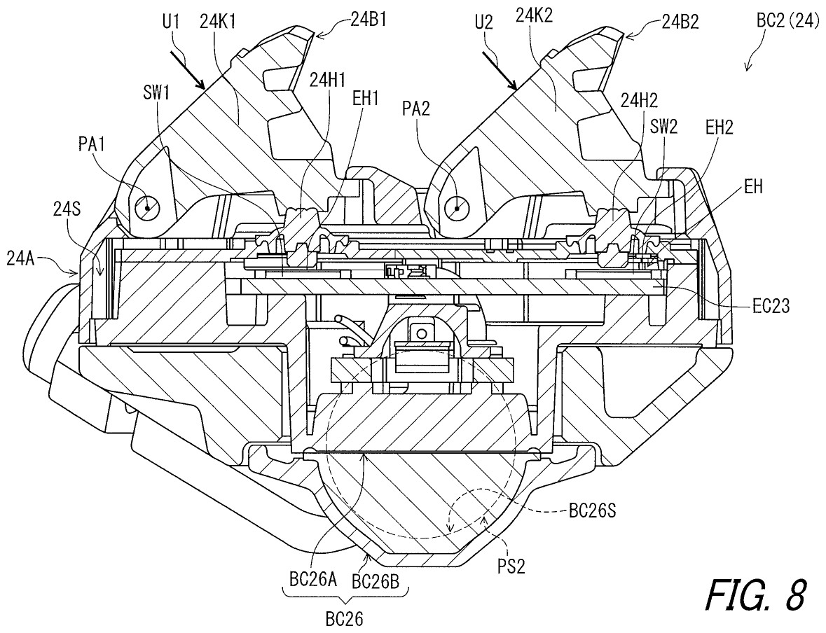

As seen in FIGS. 7 and 8, the user interface 24B is configured to receive a user input U1. The user interface 24B includes an operating member 24B1 and an electrical switch SW1. The operating member 24B1 is movably coupled to the housing 24A. The operating member 24B1 is movable relative to the housing 24A in response to the user input U1. The electrical switch SW1 is configured to be activated in response to the user input U1. The operating member 24B1 is configured to transmit the motion of the operating member 24B1 to the electrical switch SW1.

The user interface 24B is configured to receive a user input U2. The user interface 24B includes an operating member 24B2 and an electrical switch SW2. The operating member 24B2 is movably coupled to the housing 24A. The operating member 24B2 is movable relative to the housing 24A in response to the user input U2. The electrical switch SW2 is configured to be activated in response to the user input U2. The operating member 24B2 is configured to transmit the motion of the operating member 24B2 to the electrical switch SW2.

As seen in FIG. 8, the operating member 24B1 includes a user contact part 24K1 and a button 24H1. The user contact part 24K1 is pivotally coupled to the housing 24A about a pivot axis PA1. The button 24G1 is movably provided to the housing 24A. The button 24G1 is provided between the user contact part 24K1 and the electrical switch SW1.

The operating member 24B2 includes a user contact part 24K2 and a button 24H2. The user contact part 24K2 is pivotally coupled to the housing 24A about a pivot axis PA2. The button 24G2 is movably provided to the housing 24A. The button 24G2 is provided between the user contact part 24K2 and the electrical switch SW2.

The operating device 26 has substantially the same structure as the structure of the operating device 24. Thus, it will not be described in detail here for the sake of brevity.

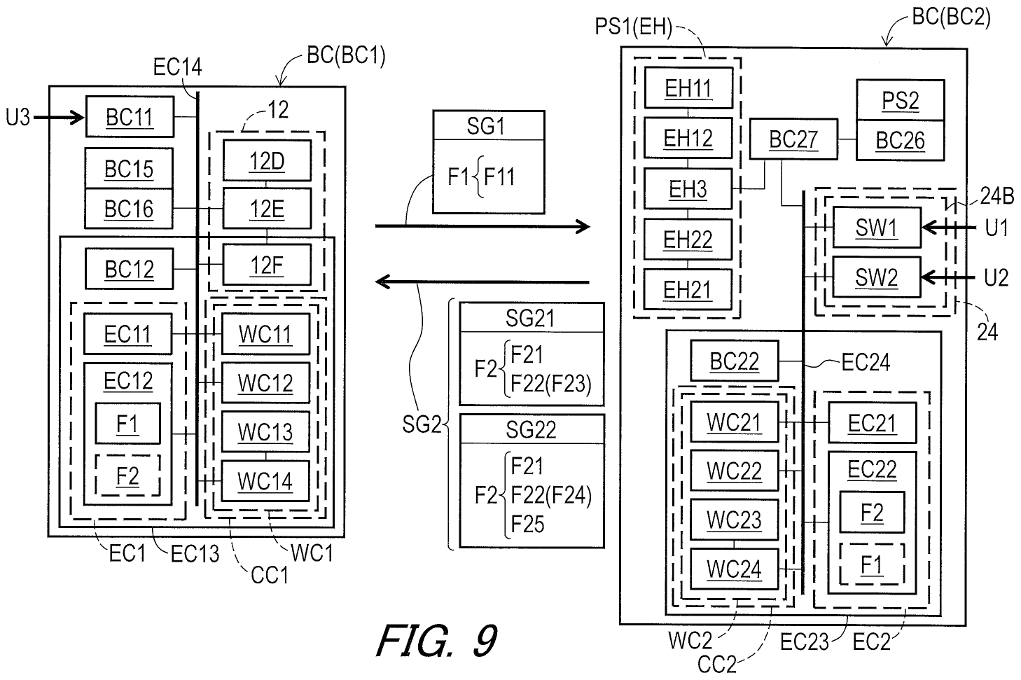

As seen in FIG. 9, the at least one human-powered vehicle component BC includes a human-powered vehicle component BC1 and a human-powered vehicle component BC2. Namely, the human-powered vehicle system 10 comprises the human-powered vehicle components BC1 and BC2. The human-powered vehicle component BC1 can be referred to as an additional human-powered vehicle component BC1. The human-powered vehicle component BC2 can be referred to as an additional human-powered vehicle component BC2.

The human-powered vehicle component BC1 includes one of the gear changer 12, the suspension 16 and/or 18, the assist drive unit 22, and the adjustable seatpost 20. The human-powered vehicle component BC2 includes one of the operating device 24 and/or 26, the gear changer 12, the suspension 16 and/or 18, the assist drive unit 22, and the adjustable seatpost 20.

In the present embodiment, the human-powered vehicle component BC1 includes the gear changer 12. The human-powered vehicle component BC2 includes the operating device 24 configured to operate the gear changer 12. Namely, the human-powered vehicle component BC1 is configured to be operated by the additional human-powered vehicle component BC2. The human-powered vehicle component BC2 is configured to operate the additional human-powered vehicle component BC1. However, the human-powered vehicle component BC1 is not limited to the gear changer 12. The human-powered vehicle component BC2 is not limited to the operating device 24. The human-powered vehicle component BC1 can include a device other than the gear changer 12 if needed or desired. The human-powered vehicle component BC2 can include a device other than the operating device 24 if needed or desired.

For example, the human-powered vehicle component BC1 can include the suspension 16 or 18 while the human-powered vehicle component BC2 can include the operating device 24 or 26. The human-powered vehicle component BC1 can include the assist drive unit 22 while the human-powered vehicle component BC2 can include the gear changer 12.

In a case where the human-powered vehicle component BC1 includes the gear changer 12, the human-powered vehicle component BC1 comprises the electric actuator 12E (see e.g., FIG. 2). In a case where the human-powered vehicle component BC1 includes the suspension 16, the human-powered vehicle component BC1 comprises the electric actuator 16E and/or 16G (see e.g., FIG. 3). In a case where the human-powered vehicle component BC1 includes the suspension 18, the human-powered vehicle component BC1 comprises the electric actuator 18E (see e.g., FIG. 4). In a case where the human-powered vehicle component BC1 includes the adjustable seatpost 20, the human-powered vehicle component BC1 comprises the electric actuator 20E (see e.g., FIG. 5). In a case where the human-powered vehicle component BC1 includes the assist drive unit 22, the human-powered vehicle component BC1 comprises the electric actuator 22E (see e.g., FIG. 6).

In a case where the human-powered vehicle component BC2 includes the operating device 24, the human-powered vehicle component BC2 includes the user interface 24B configured to be operated by the user to control the human-powered vehicle component BC1 while the human-powered vehicle B is running. The human-powered vehicle component BC2 can include another device other than the operating device 24 if needed or desired.

In the present embodiment, at least one of the human-powered vehicle component BC1 and the human-powered vehicle component BC2 has only a function relating to the human-powered vehicle B. Each of the human-powered vehicle component BC1 and the human-powered vehicle component BC2 has only the function relating to the human-powered vehicle B. However, at least one of the human-powered vehicle component BC1 and the human-powered vehicle component BC2 can has a function other than the function relating to the human-powered vehicle if needed or desired.

As seen in FIG. 9, the human-powered vehicle component BC1 comprises electronic controller circuitry EC1. The human-powered vehicle component BC1 comprises communicator circuitry CC1. The communicator circuitry CC1 is configured to communicate with another communicator circuitry. The electronic controller circuitry EC1 is coupled to the communicator circuitry CC1. The electronic controller circuitry EC1 is electrically connected to the communicator circuitry CC1.

For example, the electronic controller circuitry EC1 includes a processor EC11 and a memory EC12. The human-powered vehicle component BC1 includes a circuit board EC13 and a system bus EC14. The electronic controller circuitry EC1 is electrically mounted on the circuit board EC13. The processor EC11 and the memory EC12 are electrically mounted on the circuit board EC13. The processor EC11 is coupled to the memory EC12. The memory EC12 is coupled to the processor EC11. The processor EC11 is electrically connected to the memory EC12 via the circuit board EC13 and the system bus EC14. The memory EC12 is electrically connected to the processor EC11 via the circuit board EC13 and the system bus EC14. For example, the electronic controller circuitry EC1 includes a semiconductor. The processor EC11 includes a semiconductor. The memory EC12 includes a semiconductor. However, the electronic controller circuitry EC1 can be free of a semiconductor if needed or desired. The processor EC11 can be free of a semiconductor if needed or desired. The memory EC12 can be free of a semiconductor if needed or desired.

For example, the processor EC11 includes at least one of a central processing unit (CPU), a micro processing unit (MPU), and a memory controller. The memory EC12 is electrically connected to the processor EC11. For example, the memory EC12 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC12 includes storage areas each having an address. The processor EC11 is configured to control the memory EC12 to store data in the storage areas of the memory EC12 and reads data from the storage areas of the memory EC12. The processor EC11 can also be referred to as a hardware processor EC11 or a processor circuit or circuitry EC11. The memory EC12 can also be referred to as a hardware memory EC12 or a memory circuit or circuitry EC12. The memory EC12 can also be referred to as a non-transitory computer-readable storage medium EC12. Namely, the electronic controller circuitry EC1 includes the non-transitory computer-readable storage medium EC12.

The electronic controller circuitry EC1 is configured to execute at least one control algorithm of the human-powered vehicle component BC1. For example, the electronic controller circuitry EC1 is programed to execute at least one control algorithm of the human-powered vehicle component BC1. The memory EC12 stores at least one program including at least one program instruction. The at least one program is read into the processor EC11, and thereby the at least one control algorithm of the human-powered vehicle component BC1 is executed based on the at least one program.

The structure of the electronic controller circuitry EC1 is not limited to the above structure. The structure of the electronic controller circuitry EC1 is not limited to the processor EC11 and the memory EC12. The electronic controller circuitry EC1 can be realized by hardware alone or a combination of hardware and software. In the present embodiment, the processor EC11 and the memory EC12 are integrated as a single chip such as an application specific integrated circuit (ASIC) or a field programmable gate array (FPGA). However, the processor EC11 and the memory EC12 can be separate chips if needed or desired. The electronic controller circuitry EC1 can include the processor EC11, the memory EC12, the circuit board EC13, and the system bus EC14 if needed or desired.

The electronic controller circuitry EC1 can include at least two electronic controller circuits which are separately provided. The at least one control algorithm of the human-powered vehicle component BC1 can be executed by the at least two electronic controller circuits if needed or desired. The electronic controller circuitry EC1 can include at least two processors which are separately provided. The electronic controller circuitry EC1 can include at least two memories which are separately provided. The at least one control algorithm of the human-powered vehicle component BC1 can be executed by the at least two processors if needed or desired. The at least one control algorithm of the human-powered vehicle component BC1 can be stored in the at least two memories if needed or desired. The electronic controller circuitry EC1 can include at least two circuit boards which are separately provided if needed or desired. The electronic controller circuitry EC1 can include at least two system buses which are separately provided if needed or desired.

The communicator circuitry CC1 is electrically mounted on the circuit board EC13. The communicator circuitry CC1 is electrically connected to the processor EC11 and the memory EC12 with the circuit board EC13 and the system bus EC14.

The communicator circuitry CC1 includes wireless communicator circuitry WC1 configured to wirelessly communicate with another wireless communicator circuitry. The wireless communicator circuitry WC1 is configured to establish a wireless connection between the wireless communicator circuitry WC1 and another wireless communicator circuitry. The wireless communicator circuitry WC1 is configured to be paired with another wireless communicator circuitry. The wireless communicator circuitry WC1 is electrically mounted on the circuit board EC13. The wireless communicator circuitry WC1 is electrically connected to the processor EC11 and the memory EC12 with the circuit board EC13 and the system bus EC14.

For example, the wireless communicator circuitry WC1 includes signal transmitting circuitry WC11, signal receiving circuitry WC12, and antenna circuitry WC13. The signal transmitting circuitry WC11 is electrically connected to the antenna circuitry WC13. The signal receiving circuitry WC12 is electrically connected to the antenna circuitry WC13.

The wireless communicator circuitry WC1 is configured to transmit wireless signals via the antenna circuitry WC13. The wireless communicator circuitry WC1 is configured to superimpose digital signals on carrier wave using a predetermined wireless communication protocol to wirelessly transmit signals. In the present embodiment, the wireless communicator circuitry WC1 is configured to encrypt signals using a cryptographic key to generate encrypted wireless signals.

The wireless communicator circuitry WC1 is configured to receive wireless signals via the antenna circuitry WC13. In the present embodiment, the wireless communicator circuitry WC1 is configured to decode the wireless signals to recognize signals transmitted from other wireless communicators. The wireless communicator circuitry WC1 is configured to decrypt the wireless signals using the cryptographic key.

The wireless communicator circuitry WC1 includes a signal amplifier WC14. The signal amplifier WC14 is coupled to the signal transmitting circuitry WC11, the signal receiving circuitry WC12, and the antenna circuitry WC13. The signal amplifier WC14 is configured to selectively amplify the signals of the antenna circuitry WC13. The signal amplifier WC14 can be controlled by the electronic controller circuitry EC1. The electronic controller circuitry EC1 can be configured to control the signal amplifier WC14 such that the signal amplifier WC14 operates in a low or high power consumption state.

The human-powered vehicle component BC1 can include wired communicator circuitry and a cable connector. The wired communicator circuitry is electrically connected to the electronic controller circuitry EC1. The cable connector is electrically connected to the wired communicator circuitry. The wired communicator circuitry is configured to communicate with another wired communicator circuitry via the cable connector and an electric cable connected to the cable connector.

For example, the wired communicator circuitry can be configured to communicate with another wired communicator circuitry using power line communication (PLC) technology. The electric cable includes a ground line and a voltage line that are detachably connected to a serial bus that is formed by communication interfaces. The wired communicator circuitry is configured to communicate with another wired communication circuitry through the voltage line using the PLC technology.

As seen in FIG. 9, the human-powered vehicle component BC1 further comprises a user interface BC11 configured to receive a user operation U3. The electronic controller circuitry EC1 is electrically connected to the user interface BC11 to detect the user operation U3 received by the user interface BC11. Examples of the user interface BC11 include an electrical switch. The user operation U3 indicates at least one of an on-operation, an off-operation, transmission of a signal, and a change in a state of the human-powered vehicle component BC1. The user interface BC11 can be omitted from the human-powered vehicle component BC1 if needed or desired.

The human-powered vehicle component BC1 includes a notification device BC12. The notification device BC12 is configured to be controlled by the electronic controller circuitry EC1. Here, the notification device BC12 includes a light emitting device. For example, the notification device BC12 includes one or more light emitting diodes (LEDs). Here, the notification device BC12 includes a red LED, a blue LED and a green LED that can be selectively illuminated by the electronic controller circuitry EC1 to produce different colors of light. In other words, the electronic controller circuitry EC1 is configured to control the notification device BC12 to selectively illuminate the LEDs of the notification device BC12. The electronic controller circuitry EC1 is configured to control the notification device BC12 to produce a notification (e.g., a solid continuous light or a flashing light of a predetermined color) indicating that a particular situation is occurring or has been completed.

The notification device BC12 is visible through a transparent window portion of a housing of the human-powered vehicle component BC1. In a case where the human-powered vehicle component BC1 includes the gear changer 12, for example, the notification device BC12 is visible through a transparent window portion of at least one of the base member 12A, the movable member 12B, and other parts.

As seen in FIG. 9. the human-powered vehicle component BC1 includes an electric power source BC15 and a power source holder BC16. The power source holder BC16 is configured to detachably and reattachably hold the electric power source BC15. Examples of the electric power source BC15 includes a primary battery and/or a secondary battery. The power source holder BC16 is configured to be electrically connected to the electronic controller circuitry EC1, the communicator circuitry CC1, the wireless communicator circuitry WC1, the notification device BC12, and other electronic parts of the human-powered vehicle component BC1. The power source holder BC16 is configured to be electrically connected to the electric actuator 12E, the actuator driver 12F, and other electronic parts of the gear changer 12.

The electric power source BC15 is configured to supply electrical power to the electronic controller circuitry EC1, the communicator circuitry CC1, the wireless communicator circuitry WC1, the notification device BC12, and other electronic parts of the human-powered vehicle component BC1 via the power source holder BC16. The electric power source BC15 is configured to supply electrical power to the electric actuator 12E, the actuator driver 12F, and other electronic parts of the gear changer 12 via the power source holder BC16. The power source holder BC16 can be electrically connected to a cable connector via an electric cable if needed or desired. The human-powered vehicle component BC1 can be configured to be powered by another electric power source electrically connected to the human-powered vehicle component BC1 via an electric cable if needed or desired.

As seen in FIG. 9, the human-powered vehicle component BC2 comprises electronic controller circuitry EC2. The human-powered vehicle component BC2 comprises communicator circuitry CC2. The communicator circuitry CC2 is configured to communicate with another communicator circuitry. The electronic controller circuitry EC2 is coupled to the communicator circuitry CC2. The electronic controller circuitry EC2 is electrically connected to the communicator circuitry CC2 to control the communicator circuitry CC2.

For example, the electronic controller circuitry EC2 includes a processor EC21 and a memory EC22. The human-powered vehicle component BC2 includes a circuit board EC23 and a system bus EC24. The electronic controller circuitry EC2 is electrically mounted on the circuit board EC23. The processor EC21 and the memory EC22 are electrically mounted on the circuit board EC23. The processor EC21 is coupled to the memory EC22. The memory EC22 is coupled to the processor EC21. The processor EC21 is electrically connected to the memory EC22 via the circuit board EC23 and the system bus EC24. The memory EC22 is electrically connected to the processor EC21 via the circuit board EC23 and the system bus EC24. For example, the electronic controller circuitry EC2 includes a semiconductor. The processor EC21 includes a semiconductor. The memory EC22 includes a semiconductor. However, the electronic controller circuitry EC2 can be free of a semiconductor if needed or desired. The processor EC21 can be free of a semiconductor if needed or desired. The memory EC22 can be free of a semiconductor if needed or desired.

For example, the processor EC21 includes at least one of a central processing unit (CPU), a micro processing unit (MPU), and a memory controller. The memory EC22 is electrically connected to the processor EC21. For example, the memory EC22 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC22 includes storage areas each having an address. The processor EC21 is configured to control the memory EC22 to store data in the storage areas of the memory EC22 and reads data from the storage areas of the memory EC22. The processor EC21 can also be referred to as a hardware processor EC21 or a processor circuit or circuitry EC21. The memory EC22 can also be referred to as a hardware memory EC22 or a memory circuit or circuitry EC22. The memory EC22 can also be referred to as a non-transitory computer-readable storage medium EC22. Namely, the electronic controller circuitry EC2 includes the non-transitory computer-readable storage medium EC22.

The electronic controller circuitry EC2 is configured to execute at least one control algorithm of the human-powered vehicle component BC2. For example, the electronic controller circuitry EC2 is programed to execute at least one control algorithm of the human-powered vehicle component BC2. The memory EC22 stores at least one program including at least one program instruction. The at least one program is read into the processor EC21, and thereby the at least one control algorithm of the human-powered vehicle component BC2 is executed based on the at least one program.

The structure of the electronic controller circuitry EC2 is not limited to the above structure. The structure of the electronic controller circuitry EC2 is not limited to the processor EC21 and the memory EC22. The electronic controller circuitry EC2 can be realized by hardware alone or a combination of hardware and software. In the present embodiment, the processor EC21 and the memory EC22 are integrated as a single chip such as an application specific integrated circuit (ASIC) or a field programmable gate array (FPGA). However, the processor EC21 and the memory EC22 can be separate chips if needed or desired. The electronic controller circuitry EC2 can include the processor EC21, the memory EC22, the circuit board EC23, and the system bus EC24 if needed or desired.

The electronic controller circuitry EC2 can include at least two electronic controller circuits which are separately provided. The at least one control algorithm of the human-powered vehicle component BC2 can be executed by the at least two electronic controller circuits if needed or desired. The electronic controller circuitry EC2 can include at least two processors which are separately provided. The electronic controller circuitry EC2 can include at least two memories which are separately provided. The at least one control algorithm of the human-powered vehicle component BC2 can be executed by the at least two processors if needed or desired. The at least one control algorithm of the human-powered vehicle component BC2 can be stored in the at least two memories if needed or desired. The electronic controller circuitry EC2 can include at least two circuit boards which are separately provided if needed or desired. The electronic controller circuitry EC2 can include at least two system buses which are separately provided if needed or desired.

The communicator circuitry CC2 is electrically mounted on the circuit board EC23. The communicator circuitry CC2 is electrically connected to the processor EC21 and the memory EC22 with the circuit board EC23 and the system bus EC24.

The communicator circuitry CC2 includes wireless communicator circuitry WC2 configured to wirelessly communicate with another wireless communicator circuitry. The wireless communicator circuitry WC2 is configured to establish a wireless connection between the wireless communicator circuitry WC2 and another wireless communicator circuitry. The wireless communicator circuitry WC2 is configured to be paired with another wireless communicator circuitry. The wireless communicator circuitry WC2 is electrically mounted on the circuit board EC23. The wireless communicator circuitry WC2 is electrically connected to the processor EC21 and the memory EC22 with the circuit board EC23 and the system bus EC24.

For example, the wireless communicator circuitry WC2 includes signal transmitting circuitry WC21, signal receiving circuitry WC22, and antenna circuitry WC23. The signal transmitting circuitry WC21 is electrically connected to the antenna circuitry WC23. The signal receiving circuitry WC22 is electrically connected to the antenna circuitry WC23.

The wireless communicator circuitry WC2 is configured to transmit wireless signals via the antenna circuitry WC23. The wireless communicator circuitry WC2 is configured to superimpose digital signals on carrier wave using a predetermined wireless communication protocol to wirelessly transmit signals. In the present embodiment, the wireless communicator circuitry WC2 is configured to encrypt signals using a cryptographic key to generate encrypted wireless signals.

The wireless communicator circuitry WC2 is configured to receive wireless signals via the antenna circuitry WC23. In the present embodiment, the wireless communicator circuitry WC2 is configured to decode the wireless signals to recognize signals transmitted from other wireless communicators. The wireless communicator circuitry WC2 is configured to decrypt the wireless signals using the cryptographic key.

The wireless communicator circuitry WC2 includes a signal amplifier WC24. The signal amplifier WC24 is coupled to the signal transmitting circuitry WC21, the signal receiving circuitry WC22, and the antenna circuitry WC23. The signal amplifier WC24 is configured to selectively amplify the signals of the antenna circuitry WC23. The signal amplifier WC24 can be controlled by the electronic controller circuitry EC2. The electronic controller circuitry EC2 can be configured to control the signal amplifier WC24 such that the signal amplifier WC24 operates in a low or high power consumption state.

The human-powered vehicle component BC2 can include wired communicator circuitry and a cable connector. The wired communicator circuitry is electrically connected to the electronic controller circuitry EC2. The cable connector is electrically connected to the wired communicator circuitry. The wired communicator circuitry is configured to communicate with another wired communicator circuitry via the cable connector and an electric cable connected to the cable connector.

For example, the wired communicator circuitry can be configured to communicate with another wired communicator circuitry using power line communication (PLC) technology. The electric cable includes a ground line and a voltage line that are detachably connected to a serial bus that is formed by communication interfaces. The wired communicator circuitry is configured to communicate with another wired communication circuitry through the voltage line using the PLC technology.

As seen in FIG. 9, the human-powered vehicle component BC2 includes a notification device BC22. The notification device BC22 is configured to be controlled by the electronic controller circuitry EC2. Here, the notification device BC22 includes a light emitting device. For example, the notification device BC22 includes one or more light emitting diodes (LEDs). Here, the notification device BC22 includes a red LED, a blue LED and a green LED that can be selectively illuminated by the electronic controller circuitry EC2 to produce different colors of light. In other words, the electronic controller circuitry EC2 is configured to control the notification device BC22 to selectively illuminate the LEDs of the notification device BC22. The electronic controller circuitry EC2 is configured to control the notification device BC22 to produce a notification (e.g., a solid continuous light or a flashing light of a predetermined color) indicating that a particular situation is occurring or has been completed.

The notification device BC22 is visible through a transparent window portion of a housing of the human-powered vehicle component BC2. In a case where the human-powered vehicle component BC2 includes the operating device 24, for example, the notification device BC22 is visible through a transparent window portion of at least one of the housing 24A, the user interface 24B, and other parts.

As seen in FIG. 9, the human-powered vehicle component BC2 is configured to be powered by at least one of a first electric power source PS1 and a second electric power source PS2. The additional human-powered vehicle component BC2 is configured to be powered by at least one of the first electric power source PS1 and the second electric power source PS2.

In the present embodiment, the first electric power source PS1 includes an energy harvesting device EH. The energy harvesting device EH is configured to generate electricity in response to physical change occurring to the additional human-powered vehicle component BC2. For example, the energy harvesting device EH is configured to generate electricity in response to physical change in at least one part of the additional human-powered vehicle component BC2.

The second electric power source PS2 includes an electric power source other than the energy harvesting device EH. For example, the second electric power source PS2 includes a battery. Examples of the battery includes a primary battery and/or a secondary battery.

In the present embodiment, the additional human-powered vehicle component BC2 is configured to be powered by the first electric power source PS1 without the second electric power source PS2. The additional human-powered vehicle component BC2 is configured to be powered by the energy harvesting device EH without the second electric power source PS2. In this case, the second electric power source PS2 can be omitted if needed or desired. However, the additional human-powered vehicle component BC2 can be configured to be powered by the second electric power source PS2 without the first electric power source PS1 or both the first electric power source PS1 and the second electric power source PS2 if needed or desired.

As seen in FIG. 9, the human-powered vehicle component BC2 can include the first electric power source PS1. The first electric power source PS1 includes the energy harvesting device EH. For example, the energy harvesting device EH includes an electric generation element EH11 and a rectifier circuit EH12. The electric generation element EH11 is configured to generate electricity in response to force applied to the electric generation element EH11. The electric generation element EH11 is configured to convert force applied to the electric generation element EH11 into electricity. Examples of the electric generation element EH11 include a piezoelectric element. The rectifier circuit EH12 is electrically connected to the electric generation element EH11 to rectify the flow of electricity which is output from the electric generation element EH11.

The energy harvesting device EH includes an electric generation element EH21 and a rectifier circuit EH22. The electric generation element EH21 is configured to generate electricity in response to force applied to the electric generation element EH21. The electric generation element EH21 is configured to convert force applied to the electric generation element EH21 into electricity. Examples of the electric generation element EH21 include a piezoelectric element. The rectifier circuit EH22 is electrically connected to the electric generation element EH11 to rectify the flow of electricity which is output from the electric generation element EH21.

The energy harvesting device EH includes an electric power storage EH3. The electric power storage EH3 is electrically connected to the rectifier circuits EH12 and EH22 to store electricity which is output from at least one of the rectifier circuits EH12 and EH22. Examples of the electric power storage EH3 includes a capacitor.

As seen in FIG. 8, the electric generation element EH1 is provided between the operating member 24B1 and the electrical switch SW1. The electric generation element EH1 is provided between the button 24G1 and the electrical switch SW1. The electric generation element EH1 is configured to convert force applied from the operating member 24B1 to the electric generation element EH1 into electricity. Thus, the electric generation element EH1 is configured to generate electricity in response to the motion of the operating member 24B1.

The electric generation element EH2 is provided between the operating member 24B2 and the electrical switch SW2. The electric generation element EH2 is provided between the button 24G2 and the electrical switch SW2. The electric generation element EH2 is configured to convert force applied from the operating member 24B2 to the electric generation element EH2 into electricity. Thus, the electric generation element EH2 is configured to generate electricity in response to the motion of the operating member 24B2.

As seen in FIG. 9, the human-powered vehicle component BC2 includes a power source holder BC26. The human-powered vehicle component BC2 can include the second electric power source PS2. The power source holder BC26 is configured to detachably and reattachably hold the second electric power source PS2. Examples of the second electric power source PS2 includes a primary battery and/or a secondary battery. The power source holder BC26 is configured to be electrically connected to the electronic controller circuitry EC2, the communicator circuitry CC2, the wireless communicator circuitry WC2, and other electronic parts of the human-powered vehicle component BC2. The power source holder BC26 is configured to be electrically connected to the operating device 24.

The second electric power source PS2 is configured to supply electrical power to the electronic controller circuitry EC2, the communicator circuitry CC2, the wireless communicator circuitry WC2, and other electronic parts of the human-powered vehicle component BC2 via the power source holder BC26. The second electric power source PS2 is configured to supply electrical power to the operating device 24 via the power source holder BC26. The power source holder BC26 can be electrically connected to a cable connector via an electric cable if needed or desired. The human-powered vehicle component BC2 can be configured to be powered by another electric power source electrically connected to the human-powered vehicle component BC2 via an electric cable if needed or desired. In the case of that the human-powered vehicle component BC2 is configured to be powered by the energy harvesting device EH without the second electric power source PS2, the power source holder BC26 can be omitted if needed or desired.

The human-powered vehicle component BC2 includes a voltage controller BC27. The voltage controller BC27 is configured to control a voltage supplied from at least one of the first electric power source PS1 and the second electric power source PS2. The voltage controller BC27 is electrically connected to the energy harvesting device EH and the power source holder BC26. The voltage controller BC27 is electrically connected to the electric power storage EH3 and the power source holder BC26. In a state where the second electric power source PS2 is held by the power source holder BC26 and where the second electric power source PS2 is charged, the voltage controller BC27 supplies electricity from the second electric power source PS2 to the electronic controller circuitry EC2 and the communicator circuitry CC2. In a state where the second electric power source PS2 is detached from the power source holder BC26 or where the second electric power source PS2 is not charged, the voltage controller BC27 supplies electricity from the electric power storage EH3 of the energy harvesting device EH to the electronic controller circuitry EC2 and the communicator circuitry CC2.

As seen in FIG. 9, the human-powered vehicle component BC1 is configured to transmit a signal SG1 to another human-powered vehicle component such as the human-powered vehicle component BC2. The communicator circuitry CC1 is configured to transmit the signal SG1. The wireless communicator circuitry WC1 is configured to wirelessly transmit the signal SG1. The electronic controller circuitry EC1 is configured to control the communicator circuitry CC1 to transmit the signal SG1. The electronic controller circuitry EC1 is configured to control the wireless communicator circuitry WC1 to wirelessly transmit the signal SG1.

The human-powered vehicle component BC2 is configured to receive the signal SG1 from the human-powered vehicle component BC1. The communicator circuitry CC2 is configured to receive the signal SG1 from the communicator circuitry CC1 of the human-powered vehicle component BC1. The wireless communicator circuitry WC2 is configured to wirelessly receive the signal SG1 from the wireless communicator circuitry WC1 of the human-powered vehicle component BC1. The electronic controller circuitry EC2 is configured to recognize the signal SG1 received by the communicator circuitry CC2. The electronic controller circuitry EC2 is configured to recognize the signal SG1 received by the wireless communicator circuitry WC2.

The human-powered vehicle component BC2 is configured to transmit a signal SG2 to another human-powered vehicle component such as the human-powered vehicle component BC1. The communicator circuitry CC2 is configured to transmit the signal SG2. The wireless communicator circuitry WC2 is configured to wirelessly transmit the signal SG2. The electronic controller circuitry EC2 is configured to control the communicator circuitry CC2 to transmit the signal SG2. The electronic controller circuitry EC2 is configured to control the wireless communicator circuitry WC2 to wirelessly transmit the signal SG2.

The human-powered vehicle component BC1 is configured to receive the signal SG2 from the human-powered vehicle component BC2. The communicator circuitry CC1 is configured to receive the signal SG2 from the communicator circuitry CC2 of the human-powered vehicle component BC2. The wireless communicator circuitry WC1 is configured to wirelessly receive the signal SG2 from the wireless communicator circuitry WC2 of the human-powered vehicle component BC2. The electronic controller circuitry EC1 is configured to recognize the signal SG2 received by the communicator circuitry CC1. The electronic controller circuitry EC1 is configured to recognize the signal SG2 received by the wireless communicator circuitry WC1.

The communicator circuitry CC1 is configured to transmit the signal SG1 including information F1. The communicator circuitry CC2 is configured to receive the signal SG1 including the information F1 from the additional human-powered vehicle component BC1. The information F1 relates to the human-powered vehicle component BC1. The information F1 includes identification information F11 of the additional human-powered vehicle component BC1. The identification information F11 includes a unique number indicating the human-powered vehicle component BC1. Examples of the unique number include an address of the human-powered vehicle component BC1. The electronic controller circuitry EC1 is configured to store the information F1 in the memory EC12. The electronic controller circuitry EC1 is configured to store the identification information F11 in the memory EC12.

The communicator circuitry CC2 is configured to transmit the signal SG2 including information F2. The communicator circuitry CC1 is configured to receive the signal SG2 including the information F2 from the additional human-powered vehicle component BC2. The information F2 is included in the signal SG2 transmitted from the additional human-powered vehicle component BC2. The information F2 relates to the human-powered vehicle component BC2. The information F2 includes identification information F21 of the human-powered vehicle component BC2. The information F2 includes the identification information F21 of the additional human-powered vehicle component BC2. The identification information F21 includes a unique number indicating the human-powered vehicle component BC2. Examples of the unique number include an address of the human-powered vehicle component BC2. The electronic controller circuitry EC2 is configured to store the information F2 in the memory EC22. The electronic controller circuitry EC2 is configured to store the identification information F21 in the memory EC22.

As seen in FIGS. 9 to 11, the electronic controller circuitry EC1 is configured to obtain whether the additional human-powered vehicle component BC2 is powered by the first electric power source PS1 based on the information F2 relating to the additional human-powered vehicle component BC2. In the present embodiment, the electronic controller circuitry EC1 is configured to obtain whether the additional human-powered vehicle component BC2 is powered by the energy harvesting device EH based on the information F2 relating to the additional human-powered vehicle component BC2. The electronic controller circuitry EC1 is configured to obtain whether the additional human-powered vehicle component BC2 is currently powered by the energy harvesting device EH based on the information F2.

The communicator circuitry CC2 is configured to transmit the signal SG2 including the information F2 indicating whether the human-powered vehicle component BC2 is powered by the first electric power source PS1. The communicator circuitry CC2 is configured to transmit the signal SG2 including the information F2 indicating whether the human-powered vehicle component BC2 is powered by the energy harvesting device EH.

The information F2 includes attribute information F22 of the additional human-powered vehicle component BC2. The attribute information F22 indicates which kind of electric power source powers the human-powered vehicle component BC2. The electronic controller circuitry EC2 is configured to store the attribute information F22 in the memory EC22.

The attribute information F22 includes first energy information F23. The first energy information F23 indicates that the human-powered vehicle component BC2 is powered by the first electric power source PS1 in a case where the human-powered vehicle component BC2 is powered by the first electric power source PS1. The attribute information F22 includes the first energy information F23 in a case where the human-powered vehicle component BC2 is powered by the energy harvesting device EH. The electronic controller circuitry EC2 is configured to store the first energy information F23.

The electronic controller circuitry EC2 is configured to control the communicator circuitry CC2 to transmit the signal SG2 including the first energy information F23. The communicator circuitry CC2 is configured to transmit the signal SG2 including the first energy information F23 indicating that the human-powered vehicle component BC2 is powered by the first electric power source PS1 in the case where the human-powered vehicle component BC2 is powered by the first electric power source PS1. The communicator circuitry CC2 is configured to transmit the signal SG2 including the first energy information F23 indicating that the human-powered vehicle component BC2 is powered by the energy harvesting device EH in the case where the human-powered vehicle component BC2 is powered by the energy harvesting device EH.

The signal SG2 includes a first signal SG21. The electronic controller circuitry EC2 is configured to control the communicator circuitry CC2 to transmit the first signal SG21 including the first energy information F23 in a case where the human-powered vehicle component BC2 is powered by the first electric power source PS1. The electronic controller circuitry EC2 is configured to control the communicator circuitry CC2 to transmit the first signal SG21 including the first energy information F23 in a case where the human-powered vehicle component BC2 is powered by the energy harvesting device EH.

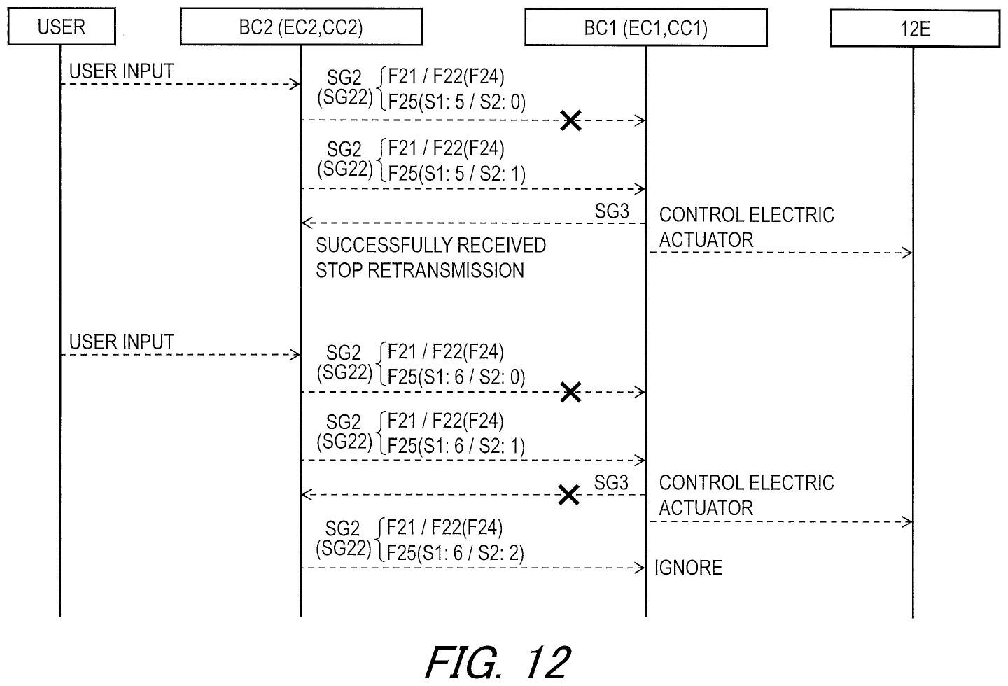

As seen in FIGS. 9 and 12, the attribute information F22 includes second energy information F24 indicating that the human-powered vehicle component BC2 is powered by an electric power source other than the first electric power source PS1 in a case where the human-powered vehicle component BC2 is powered by the electric power source other than the first electric power source PS1. The attribute information F22 includes second energy information F24 indicating that the human-powered vehicle component BC2 is powered by an electric power source other than the energy harvesting device EH in a case where the human-powered vehicle component BC2 is powered by the electric power source other than the energy harvesting device EH. The attribute information F22 includes the second energy information F24 indicating that the human-powered vehicle component BC2 is powered by the second electric power source PS2 in a case where the human-powered vehicle component BC2 is powered by the second electric power source PS2. The electronic controller circuitry EC2 is configured to store the second energy information F24.

The electronic controller circuitry EC2 is configured to control the communicator circuitry CC2 to transmit the signal SG2 including the second energy information F24. The communicator circuitry CC2 is configured to transmit the signal SG2 including the second energy information F24 indicating that the human-powered vehicle component BC2 is powered by the electric power source other than the first electric power source PS1 in the case where the human-powered vehicle component BC2 is powered by the electric power source other than the first electric power source PS1. The communicator circuitry CC2 is configured to transmit the signal SG2 including the second energy information F24 indicating that the human-powered vehicle component BC2 is powered by the electric power source other than the energy harvesting device EH in the case where the human-powered vehicle component BC2 is powered by the electric power source other than the energy harvesting device EH. The communicator circuitry CC2 is configured to transmit the signal SG2 including the second energy information F24 indicating that the human-powered vehicle component BC2 is powered by the second electric power source PS2 in the case where the human-powered vehicle component BC2 is powered by the second electric power source PS2.

The signal SG2 includes a second signal SG22. The electronic controller circuitry EC2 is configured to control the communicator circuitry CC2 to transmit the second signal SG22 including the second energy information F24 indicating that the human-powered vehicle component BC2 is powered by an electric power source other than the first electric power source PS1 in a case where the human-powered vehicle component BC2 is powered by the electric power source other than the first electric power source PS1. The electronic controller circuitry EC2 is configured to control the communicator circuitry CC2 to transmit the second signal SG22 including the second energy information F24 indicating that the human-powered vehicle component BC2 is powered by an electric power source other than the energy harvesting device EH in a case where the human-powered vehicle component BC2 is powered by the electric power source other than the energy harvesting device EH. The electronic controller circuitry EC2 is configured to control the communicator circuitry CC2 to transmit the second signal SG22 including the second energy information F24 indicating that the human-powered vehicle component BC2 is powered by the second electric power source PS2 in a case where the human-powered vehicle component BC2 is powered by the second electric power source PS2.

The electronic controller circuitry EC2 is configured to control the communicator circuitry CC2 to transmit the second signal SG22 including sequence information F25 in a case where the human-powered vehicle component BC2 is powered by the electric power source other than the first electric power source PS1. The electronic controller circuitry EC2 is configured to control the communicator circuitry CC2 to transmit the second signal SG22 including the sequence information F25 in a case where the human-powered vehicle component BC2 is powered by the electric power source other than the energy harvesting device EH.

As seen in FIG. 12, for example, the sequence information F25 includes a total operation number S1 indicating: a total number of the receipt of the user input received by the user interface 24B; a total number of the actuation of the electric actuator 12E; or a total number of the gear change executed in the gear changer 12. The electronic controller circuitry EC2 is configured to update the total operation number S1 in a case where the electronic controller circuitry EC2 recognizes the user input U1 or U2 received by the user interface 24B.

The sequence information F25 includes a total number of retransmissions S2 of the second signal SG22 executed in response to each user input. The electronic controller circuitry EC2 is configured to control the communicator circuitry CC2 to transmit the second signal SG22 including “0” in a case where the communicator circuitry CC2 first transmits the second signal SG22 in response to each user input. The electronic controller circuitry EC2 is configured to control the communicator circuitry CC2 to transmit the second signal SG22 including “1” in a case where the communicator circuitry CC2 retransmits the second signal SG22. The electronic controller circuitry EC2 is configured to control the communicator circuitry CC2 to transmit the second signal SG22 including “2” in a case where the communicator circuitry CC2 retransmits the second signal SG22 again.

As seen in FIGS. 9 to 11, the electronic controller circuitry EC2 is configured to control the communicator circuitry CC2 to transmit the first signal SG21 which is free of the sequence information F25 in the case where the human-powered vehicle component BC2 is powered by the first electric power source PS1. The electronic controller circuitry EC2 is configured to control the communicator circuitry CC2 to transmit the first signal SG21 which is free of the sequence information F25 in the case where the human-powered vehicle component BC2 is powered by the energy harvesting device EH. The sequence information F25 includes a total number of retransmissions of the signal SG2. The sequence information F25 includes a total number of retransmissions of the first signal SG21. The sequence information F25 can include a total number of transmissions of the first signal SG21 rather than “retransmissions.”

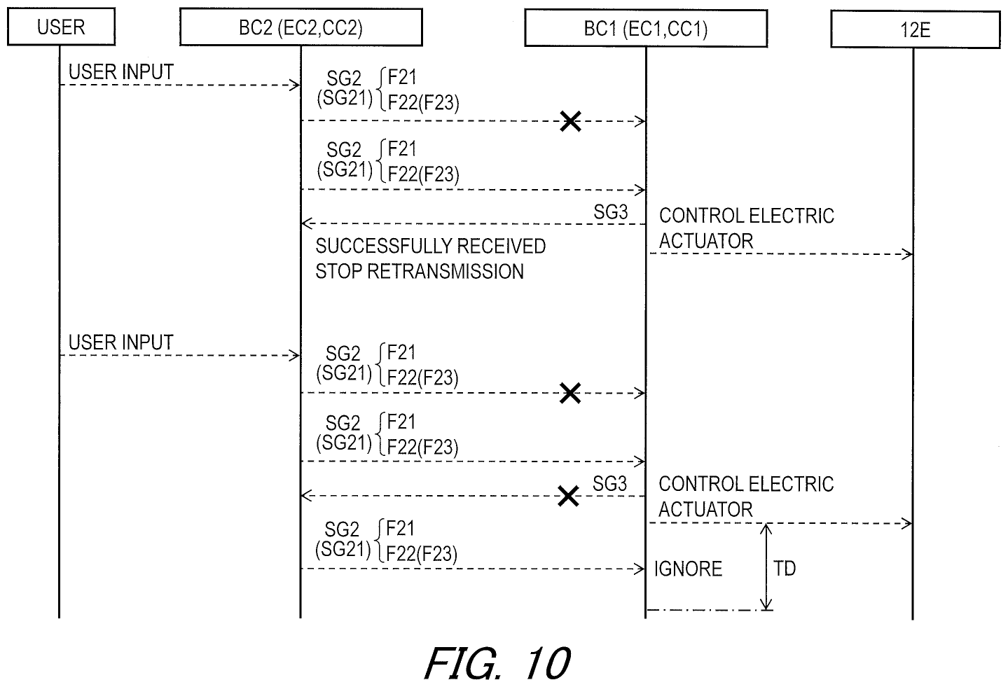

As seen in FIGS. 10 to 12, the electronic controller circuitry EC1 is configured to control the electric actuator 12E based on whether the additional human-powered vehicle component BC2 is powered by the first electric power source PS1. The electronic controller circuitry EC1 is configured to control the electric actuator 12E based on whether the additional human-powered vehicle component BC2 is powered by the energy harvesting device EH.

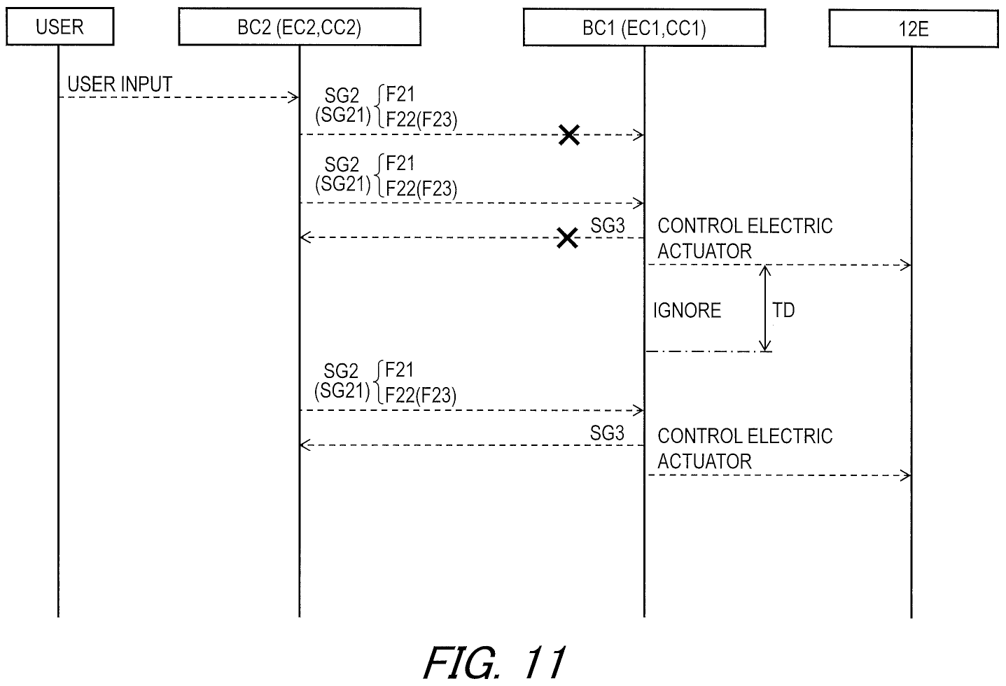

As seen in FIGS. 10 and 11, the electronic controller circuitry EC1 is configured to execute a first control in a case where the additional human-powered vehicle component BC2 is powered by the first electric power source PS1. The electronic controller circuitry EC1 is configured to execute the first control in a case where the additional human-powered vehicle component BC2 is powered by the energy harvesting device EH.

As seen in FIG. 12, the electronic controller circuitry EC1 is configured to execute a second control different from the first control in a case where the additional human-powered vehicle component BC2 is powered by an electric power source other than the first electric power source PS1. The electronic controller circuitry EC1 is configured to execute the second control different from the first control in a case where the additional human-powered vehicle component BC2 is powered by an electric power source other than the energy harvesting device EH. The electronic controller circuitry EC1 is configured to execute a second control different from the first control in a case where the additional human-powered vehicle component BC2 is powered by the second electric power source PS2.

As seen in FIGS. 10 and 11, the electronic controller circuitry EC1 is configured to control, in the first control, the electric actuator 12E to move the movable member 12B in response to the signal SG2 in a case where a first condition is met. The electronic controller circuitry EC1 is configured to ignore, in the first control, the signal SG2 indicating that the electric actuator 12E moves the movable member 12B in a case where the first condition is not met.

For example, the electronic controller circuitry EC1 is configured to control, in the first control, the electric actuator 12E to move the movable member 12B in a case where the first condition that a determination time TD elapses from a previous action in which the electric actuator 12E moves the movable member 12B is met. The electronic controller circuitry EC1 is configured to ignore, in the first control, the signal SG2 indicating that the electric actuator 12E moves the movable member 12B in a case where the first condition that the determination time TD elapses from the previous action in which the electric actuator 12E moves the movable member 12B is not met.

The determination time TD can be measured from one of: a start of the previous action; an end of the previous action; and any timing during the previous action. For example, the determination time TD can be measured from one of: a timing at which the electric actuator 12E starts to move the movable member 12B; a timing at which the electric actuator 12E stops moving the movable member 12B; and any timing while the electric actuator 12E is moving the movable member 12B.

As seen in FIG. 12, the electronic controller circuitry EC1 is configured to control, in the second control, the electric actuator 12E to move the movable member 12B in response to the signal SG2 in a case where a second condition different from the first condition is met. The electronic controller circuitry EC1 is configured to ignore, in the second control, the signal SG2 indicating that the electric actuator 12E moves the movable member 12B in a case where the second condition is not met.

The electronic controller circuitry EC1 is configured to control, in the second control, the electric actuator 12E to move the movable member 12B in a case where the second condition which is free of the determination time TD is met. For example, the electronic controller circuitry EC1 is configured to control, in the second control, the electric actuator 12E to move the movable member 12B in a case where the second condition that the sequence information F25 included in the signal SG2 is different from previous sequence information F25 included in a previous signal SG2 previously received by the human-powered vehicle component BC1 is met.

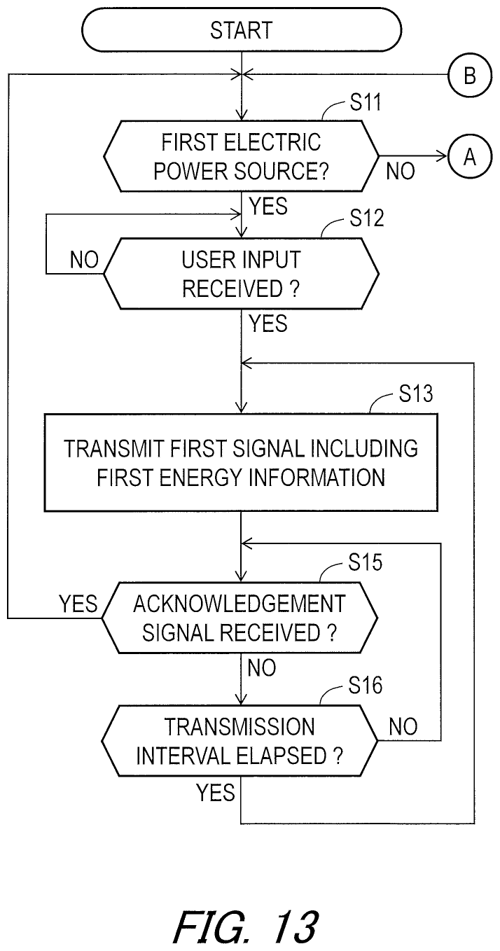

The control executed by the human-powered vehicle component BC2 will be discussed in detail below referring to FIGS. 13 and 14.

As seen in FIG. 13, in step S11, the electronic controller circuitry EC2 of the human-powered vehicle component BC2 determines whether the human-powered vehicle component BC2 is powered by the first electric power source PS1. The process proceeds to step S12 in a case where the human-powered vehicle component BC2 is powered by the first electric power source PS1. The process proceeds to step S22 of FIG. 14 in a case where the human-powered vehicle component BC2 is powered by an electric power source other than the first electric power source PS1.

In step S12, the electronic controller circuitry EC2 determines whether the user interface 24B receives the user input U1 or U2 in a case where the human-powered vehicle component BC2 is powered by the first electric power source PS1. In step S13, the electronic controller circuitry EC2 controls the communicator circuitry CC2 to transmit, to the human-powered vehicle component BC1, the first signal SG21 including the first energy information F23 provided as the attribute information F22 in a case where the user interface 24B receives the user input U1 or U2 (see e.g., FIG. 10 or 11). The electronic controller circuitry EC2 controls the communicator circuitry CC2 to transmit, to the human-powered vehicle component BC1, the first signal SG21 including the first energy information F23 provided as the attribute information F22 in the case where the user interface 24B receives the user input U1 or U2 (see e.g., FIG. 10 or 11). The first signal SG21 is free of the sequence information F25. The first signal SG21 indicates upshifting or downshifting corresponding to the user input U1 or U2 in the case where the human-powered vehicle component BC1 includes the gear changer 12.

In step S15, the electronic controller circuitry EC2 determines whether the communicator circuitry CC2 receives an acknowledgement signal SG3 from the human-powered vehicle component BC1 (see e.g., FIG. 10 or 11). The process returns to step S11 in a case where the communicator circuitry CC2 has received the acknowledgement signal SG3 from the human-powered vehicle component BC1 after the transmission of the first signal SG21.

In step S16, the electronic controller circuitry EC2 determines whether the transmission interval has elapsed from the transmission of the first signal SG21 in a case where the communicator circuitry CC2 has not received the acknowledgement signal SG3 from the human-powered vehicle component BC1 in step S15. The process returns to step S15 in a case where the transmission interval has not elapsed from the transmission of the first signal SG21. The process returns to step S13 in a case where the transmission interval has elapsed from the transmission of the first signal SG21, and then the first signal SG21 is transmitted again.

As seen in FIG. 14, in step S22, the electronic controller circuitry EC2 determines whether the user interface 24B receives the user input U1 or U2 in a case where the human-powered vehicle component BC2 is powered by the second electric power source PS2. In step S23, the electronic controller circuitry EC2 controls the communicator circuitry CC2 to transmit, to the human-powered vehicle component BC1, the second signal SG22 including: the second energy information F24, which is provided as the attribute information F22; and the sequence information F25 in a case where the user interface 24B receives the user input U1 or U2 (scc e.g., FIG. 12). The electronic controller circuitry EC2 controls the communicator circuitry CC2 to transmit, to the human-powered vehicle component BC1, the second signal SG22 including: the second energy information F24, which is provided as the attribute information F22; and the sequence information F25 in the case where the user interface 24B receives the user input U1 or U2 (see e.g., FIG. 12). The second signal SG22 indicates upshifting or downshifting corresponding to the user input U1 or U2 in the case where the human-powered vehicle component BC1 includes the gear changer 12.

In step S24, the electronic controller circuitry EC2 updates the sequence information F25. For example, the electronic controller circuitry EC2 updates the total number of retransmissions S2 included in the sequence information F25. The electronic controller circuitry EC2 increments the total number of retransmissions S2 included in the sequence information F25 by one.

In step S25, the electronic controller circuitry EC2 determines whether the communicator circuitry CC2 receives the acknowledgement signal SG3 from the human-powered vehicle component BC1. The process proceeds to step S26 in a case where the communicator circuitry CC2 has not received the acknowledgement signal SG3 from the human-powered vehicle component BC1. The process proceeds to step S27 in a case where the communicator circuitry CC2 has received the acknowledgement signal SG3 from the human-powered vehicle component BC1.

In step S26, the electronic controller circuitry EC2 determines whether the transmission interval has elapsed from the transmission of the second signal SG22 in a case where the communicator circuitry CC2 does not receive the acknowledgement signal SG3 from the human-powered vehicle component BC1 in step S25. The process returns to step S25 in a case where the transmission interval has not elapsed from the transmission of the second signal SG22. The process returns to step S23 in a case where the transmission interval has elapsed from the transmission of the second signal SG22, and then the second signal SG22 is transmitted again.

In step S27, the electronic controller circuitry EC2 updates the sequence information F25. For example, the electronic controller circuitry EC2 updates the total operation number S1 included in the sequence information F25. The electronic controller circuitry EC2 increments the total operation number S1 included in the sequence information F25 by one. The process returns to step S11 of FIG. 13.

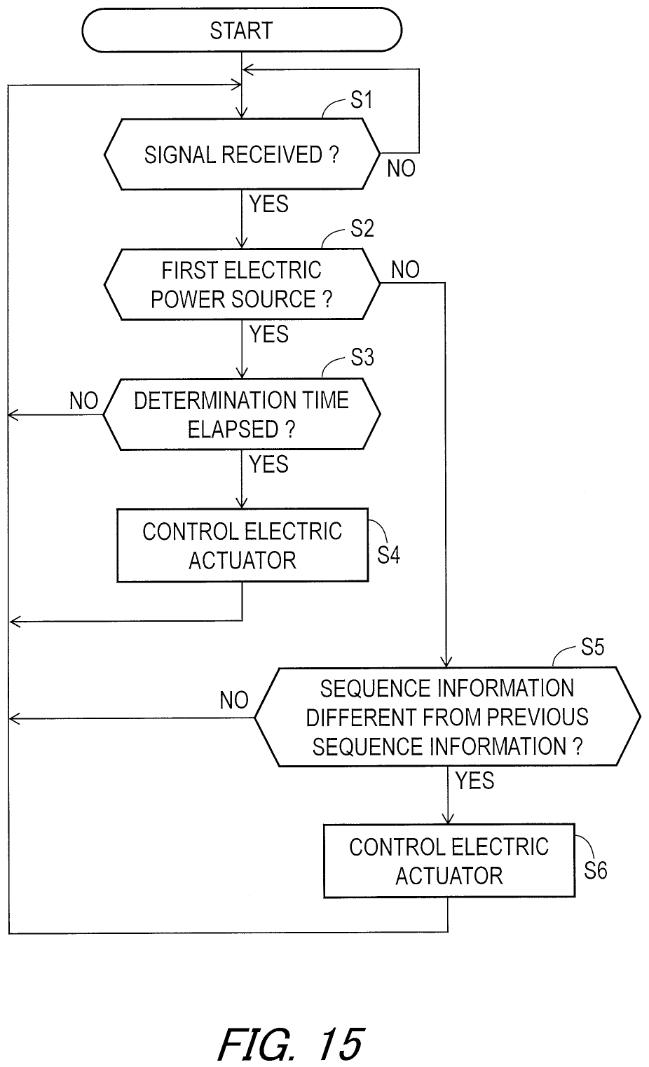

The control executed by the human-powered vehicle component BC1 will be discussed below referring to FIG. 15.

As seen in FIG. 15, in step S1, the electronic controller circuitry EC1 determines whether the communicator circuitry CC1 receives the signal SG2. For example, the electronic controller circuitry EC1 determines whether the communicator circuitry CC1 receives the first signal SG21 or the second signal SG22.

In step S2, the electronic controller circuitry EC1 determines whether the human-powered vehicle component BC2 is powered by the first electric power source PS1 or another electric power source based on the signal SG2. The human-powered vehicle component BC2 is powered by the energy harvesting device EH or another electric power source based on the signal SG2. For example, the electronic controller circuitry EC1 determines whether the human-powered vehicle component BC2 is powered by the first electric power source PS1 or the second electric power source PS2 based on the signal SG2. The electronic controller circuitry EC1 determines whether the human-powered vehicle component BC2 is powered by the energy harvesting device EH or the second electric power source PS2 based on the signal SG2.

In step S2, the electronic controller circuitry EC1 concludes that the human-powered vehicle component BC2 is powered by the first electric power source PS1 in a case where the communicator circuitry CC1 receives the first signal SG21 including the first energy information F23. For example, the electronic controller circuitry EC1 stores the first energy information F23 in the memory EC12 in advance. The electronic controller circuitry EC1 compares the first energy information F23 stored in the memory EC12 with the information F2 included in the signal SG2. The electronic controller circuitry EC1 concludes that the human-powered vehicle component BC2 is powered by the first electric power source PS1 in a case where the information F2 included in the signal SG2 matches the first energy information F23 stored in the memory EC12. The electronic controller circuitry EC1 concludes that the human-powered vehicle component BC2 is powered by an electric power source other than the first electric power source PS1 in a case where the information F2 included in the signal SG2 does not match the first energy information F23 stored in the memory EC12. The process proceeds to step S3 in a case where the human-powered vehicle component BC2 is powered by the first electric power source PS1. The process proceeds to step S5 in a case where the human-powered vehicle component BC2 is powered by an electric power source other than the first electric power source PS1.

The electronic controller circuitry EC1 concludes that the human-powered vehicle component BC2 is powered by an electric power source (e.g., the second electric power source PS2) other than the first electric power source PS1 in a case where the communicator circuitry CC1 receives the second signal SG22 including the second energy information F24. For example, the electronic controller circuitry EC1 stores the second energy information F24 in the memory EC12 in advance. The electronic controller circuitry EC1 concludes that the human-powered vehicle component BC2 is powered by an electric power source other than the first electric power source PS1 in a case where the information F2 included in the signal SG2 does not match the first energy information F23 stored in the memory EC12 or matches the second energy information F24. The process proceeds to step S6 in a case where the human-powered vehicle component BC2 is powered by an electric power source (e.g., the second electric power source PS2) other than the first electric power source PS1.

In step S3, the electronic controller circuitry EC1 determines whether the determination time TD has elapsed from the previous action in which the electric actuator 12E moved the movable member 12B (see e.g., FIG. 10 or 11). The process returns to step S1 in a case where the determination time TD has not elapsed from the previous action. Namely, the electronic controller circuitry EC1 ignores the first signal SG21 in a case where the determination time TD has not elapsed from the previous action (see e.g., FIG. 10). The process proceeds to step S4 in a case where the determination time TD has elapsed from the previous action.

In step S4, the electronic controller circuitry EC1 controls the electric actuator 12E to move the movable member 12B in response to the first signal SG21 (see e.g., FIG. 10 or 11). For example, the electronic controller circuitry EC1 controls the electric actuator 12E to move the movable member 12B in an upshifting direction in a case where the first signal SG21 indicates upshifting. The electronic controller circuitry EC1 controls the electric actuator 12E to move the movable member 12B in a downshifting direction in a case where the first signal SG21 indicates downshifting. The process returns to step S1.

In step S5, the electronic controller circuitry EC1 determines whether the sequence information F25 included in the first signal SG21 is different from the previous sequence information F25 stored in the memory EC12. For example, the electronic controller circuitry EC1 determines whether the total operation number S1 of the sequence information F25 included in the first signal SG21 is different from the total operation number S1 of the previous sequence information F25 stored in the memory EC12. Furthermore, the electronic controller circuitry EC1 determines whether the total number of retransmissions S2 of the sequence information F25 included in the first signal SG21 is different from the total number of retransmissions S2 of the previous sequence information F25 stored in the memory EC12.

The process returns to step S1 in a case where the sequence information F25 included in the first signal SG21 is the same as the previous sequence information F25 stored in the memory EC12. The process returns to step S1 in a case where the total operation number S1 and the total number of retransmissions S2 of the sequence information F25 included in the first signal SG21 are the same as the total operation number S1 and the total number of retransmissions S2 of the previous sequence information F25 stored in the memory EC12.

The process proceeds to step S6 in a case where the sequence information F25 included in the first signal SG21 is different from the previous sequence information F25 stored in the memory EC12. The process proceeds to step S6 in a case where the total operation number S1 and the total number of retransmissions S2 of the sequence information F25 included in the first signal SG21 are different from the total operation number S1 and the total number of retransmissions S2 of the previous sequence information F25 stored in the memory EC12.

In step S6, the electronic controller circuitry EC1 controls the electric actuator 12E to move the movable member 12B in response to the first signal SG21. For example, the electronic controller circuitry EC1 controls the electric actuator 12E to move the movable member 12B in an upshifting direction in a case where the first signal SG21 indicates upshifting. The electronic controller circuitry EC1 controls the electric actuator 12E to move the movable member 12B in a downshifting direction in a case where the first signal SG21 indicates downshifting. The process returns to step S1.

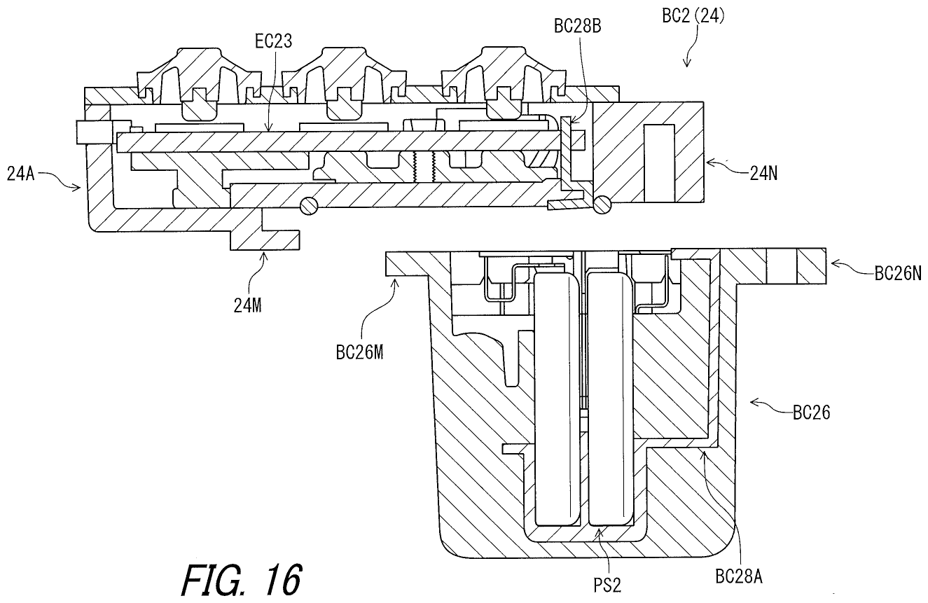

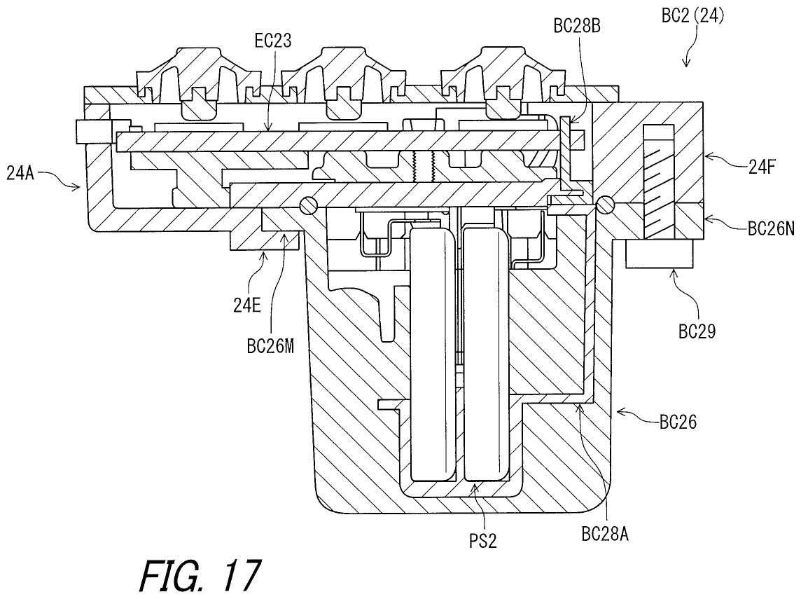

In the above embodiment and the modifications thereof, as seen in FIG. 8, the power source holder BC26 includes a holder base BC26A, a lid BC26B, and a holder space BC26S. The holder base BC26A is secured to the housing 24A. The lid BC26B is detachably and reattachably fastened to the holder base BC26A with fasteners such as screws. The holder base BC26A is at least partially provided in a housing space 24S of the housing 24A. The holder base BC26A and the lid BC26B define the holder space BC26S. The second electric power source PS2 is configured to be provided in the holder space BC26S. As seen in FIGS. 16 and 17, however, the power source holder BC26 can be detachable from and reattachable to the housing 24A if needed or desired. In the modification depicted in FIGS. 16 and 17, the power source holder BC26 includes a first coupling portion BC26M and a second coupling portion BC26N. The housing 24A includes a third coupling portion 24M and a fourth coupling portion 24N. The first coupling portion BC26M is configured to be coupled to the third coupling portion 24M. The second coupling portion BC26N is configured to be coupled to the fourth coupling portion 24N. The second coupling portion BC26N is configured to be secured to the fourth coupling portion 24N with a fastener BC29. The power source holder BC26 includes a first electric conductor BC28A. The human-powered vehicle component BC2 includes a second electric conductor BC28B. The first electric conductor BC28A is contactable with the second electric power source PS2. The second electric conductor BC28B is electrically connected to the circuit board EC23. The first electric conductor BC28A is in contact with the second electric conductor BC28B in a state where the power source holder BC26 is attached to the housing 24A. The second electric power source PC2 is electrically connected to the circuit board EC23 via the first electric conductor BC28A and the second electric conductor BC28B.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. A human-powered vehicle component configured to be operated by an additional human-powered vehicle component configured to be powered by at least one of a first electric power source and a second electric power source, the human-powered vehicle component comprising:
electronic controller circuitry configured to obtain whether the additional human-powered vehicle component is powered by the first electric power source based on information relating to the additional human-powered vehicle component.

2. The operating device according to claim 1, wherein
the first electric power source includes an energy harvesting device.

3. A human-powered vehicle component comprising:
electronic controller circuitry configured to obtain whether an additional human-powered vehicle component is powered by an energy harvesting device based on information relating to the additional human-powered vehicle component.

4. The human-powered vehicle component according to claim 2, wherein
the electronic controller circuitry is configured to obtain whether the additional human-powered vehicle component is currently powered by the energy harvesting device based on the information.

5. The human-powered vehicle component according to claim 1, wherein
the information is included in a signal transmitted from the additional human-powered vehicle component.

6. The human-powered vehicle component according to claim 1, wherein
the information includes attribute information of the additional human-powered vehicle component, and
the attribute information indicates which kind of electric power source powers the human-powered vehicle component.

7. The human-powered vehicle component according to claim 1, wherein
the information includes identification information of the additional human-powered vehicle component.

8. A human-powered vehicle component configured to be operated by an additional human-powered vehicle component configured to be powered by at least one of a first electric power source and a second electric power source, the human-powered vehicle component comprising:
an electric actuator; and
electronic controller circuitry configured to control the electric actuator based on whether the additional human-powered vehicle component is powered by the first electric power source.

9. The human-powered vehicle component according to claim 8, wherein
the first electric power source includes an energy harvesting device.

10. A human-powered vehicle component comprising:
an electric actuator; and
electronic controller circuitry configured to control the electric actuator based on whether an additional human-powered vehicle component is powered by an energy harvesting device.

11. The human-powered vehicle component according to claim 2, wherein
the electronic controller circuitry is configured to execute a first control in a case where the additional human-powered vehicle component is powered by the energy harvesting device, and
the electronic controller circuitry is configured to execute a second control different from the first control in a case where the additional human-powered vehicle component is powered by an electric power source other than the energy harvesting device.

12. The human-powered vehicle component according to claim 11, wherein
the electronic controller circuitry is configured to control, in the first control, an electric actuator to move a movable member in response to the signal in a case where a first condition is met, and
the electronic controller circuitry is configured to control, in the second control, the electric actuator to move the movable member in response to the signal in a case where a second condition different from the first condition is met.

13. The human-powered vehicle component according to claim 12, wherein
the electronic controller circuitry is configured to ignore, in the first control, the signal indicating that the electric actuator moves the movable member in a case where the first condition is not met.

14. The human-powered vehicle component according to claim 12, wherein
the electronic controller circuitry is configured to ignore, in the second control, the signal indicating that the electric actuator moves the movable member in a case where the second condition is not met.

15. The human-powered vehicle component according to claim 12, wherein
the electronic controller circuitry is configured to control, in the first control, the electric actuator to move the movable member in a case where the first condition that a determination time elapses from a previous action in which the electric actuator moves the movable member is met.

16. The human-powered vehicle component according to claim 12, wherein
the electronic controller circuitry is configured to control, in the second control, the electric actuator to move the movable member in a case where the second condition which is free of the determination time is met.

17. The human-powered vehicle component according to claim 12, wherein
the electronic controller circuitry is configured to control, in the second control, the electric actuator to move the movable member in a case where the second condition that sequence information included in the signal is different from previous sequence information included in a previous signal previously received by the human-powered vehicle component is met.

18. The human-powered vehicle component according to claim 1, further comprising
communicator circuitry configured to receive the signal including the information from the additional human-powered vehicle component.

19. A human-powered vehicle component configured to be powered by at least one of a first electric power source and a second electric power source, the human-powered vehicle component comprising:
communicator circuitry configured to transmit a signal including information indicating whether the human-powered vehicle component is powered by the first electric power source.

20. The human-powered vehicle component according to claim 19, wherein
the first electric power source includes an energy harvesting device.

21. A human-powered vehicle component comprising:
communicator circuitry configured to transmit a signal including first energy information indicating that the human-powered vehicle component is powered by an energy harvesting device.

22. The human-powered vehicle component according to claim 19, wherein
the human-powered vehicle component is configured to operate an additional human-powered vehicle component.

23. The human-powered vehicle component according to claim 19, wherein
the communicator circuitry is configured to transmit the signal including information including attribute information of the human-powered vehicle component, and
the attribute information includes which kind of electric power source powers the human-powered vehicle component.

24. The human-powered vehicle component according to claim 23, wherein
the attribute information includes the first energy information.

25. The human-powered vehicle component according to claim 23, wherein
the attribute information includes second energy information indicating that the human-powered vehicle component is powered by an electric power source other than the energy harvesting device.

26. The human-powered vehicle component according to claim 19, wherein
the information includes identification information of the human-powered vehicle component.

27. The human-powered vehicle component according to claim 21, further comprising
electronic controller circuitry electrically connected to the communicator circuitry, the electronic controller circuitry being configured to store the first energy information, the electronic controller circuitry being configured to control the communicator circuitry to transmit the signal including the first energy information.

28. The human-powered vehicle component according to claim 27, wherein
the electronic controller circuitry is configured to control the communicator circuitry to transmit a first signal including the first energy information in a case where the human-powered vehicle component is powered by the energy harvesting device, and
the electronic controller circuitry is configured to control the communicator circuitry to transmit a second signal including second energy information indicating that the human-powered vehicle component is powered by an electric power source other than the energy harvesting device in a case where the human-powered vehicle component is powered by the electric power source other than the energy harvesting device.

29. The human-powered vehicle component according to claim 27, wherein
the electronic controller circuitry is configured to control the communicator circuitry to transmit the first signal which is free of sequence information in a case where the human-powered vehicle component is powered by the energy harvesting device, and
the electronic controller circuitry is configured to control the communicator circuitry to transmit the second signal including the sequence information in a case where the human-powered vehicle component is powered by the electric power source other than the energy harvesting device.
